(19) United States
(12) Patent Application Publication
(10) Pub. No.: US 2023/0036892 A1
(43) Pub. Date: Feb. 2, 2023

(54) CONFIGURED GRANT FOR SUB-SLOT BASED PHYSICAL SIDELINK SHARED CHANNELS

(71) Applicant: QUALCOMM Incorporated, San Diego, CA (US)

(72) Inventors: Chih-Hao LIU, San Diego, CA (US); Yisheng XUE, San Diego, CA (US); Jing SUN, San Diego, CA (US); Xiaoxia ZHANG, San Diego, CA (US)

(21) Appl. No.: 17/444,270

(22) Filed: Aug. 2, 2021

(51) Int. Cl. H04W 72/14; H04W 72/12

(52) U.S. Cl. CPC H04W 72/14; H04W 72/1278

(57) ABSTRACT

Wireless communications systems and methods related to communicating control information are provided. A method of wireless communication performed by a first user equipment (UE) may include receiving, from a base station (BS), a configured grant (CG) and transmitting, to a second UE based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

### TECHNICAL FIELD

This application relates to wireless communication systems, and more particularly to methods and devices for wireless communication using slot-based and sub-slot based physical sidelink shared channels that are configured based on a grant.

### INTRODUCTION

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), each simultaneously supporting communications for multiple communication devices, which may be otherwise known as user equipment (UE).

To meet the growing demands for expanded mobile broadband connectivity, wireless communication technologies are advancing from the LTE technology to a next generation new radio (NR) technology. For example, NR is designed to provide a lower latency, a higher bandwidth or throughput, and a higher reliability than LTE. NR is designed to operate over a wide array of spectrum bands, for example, from low-frequency bands below about 1 gigahertz (GHz) and mid-frequency bands from about 1 GHz to about 6 GHz, to high-frequency bands such as millimeter wave (mmWave) bands. NR is also designed to operate across different spectrum types, from licensed spectrum to unlicensed and shared spectrum. Spectrum sharing enables operators to opportunistically aggregate spectrums to dynamically support high-bandwidth services. Spectrum sharing can extend the benefit of NR technologies to operating entities that may not have access to a licensed spectrum.

NR may support various deployment scenarios to benefit from the various spectrums in different frequency ranges, licensed and/or unlicensed, and/or coexistence of the LTE and NR technologies. For example, NR can be deployed in a standalone NR mode over a licensed and/or an unlicensed band or in a dual connectivity mode with various combinations of NR and LTE over licensed and/or unlicensed bands.

In a wireless communication network, a BS may communicate with a UE in an uplink direction and a downlink direction. Sidelink was introduced in LTE to allow a UE to send data to another UE (e.g., from one vehicle to another vehicle) without tunneling through the BS and/or an associated core network. The LTE sidelink technology has been extended to provision for device-to-device (D2D) communications, vehicle-to-everything (V2X) communications, and/or cellular vehicle-to-everything (C-V2X) communications. Similarly, NR may be extended to support sidelink communications, D2D communications, V2X communications, and/or C-V2X over licensed bands and/or unlicensed bands.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

For example, in an aspect of the disclosure, a method of wireless communication performed by a user equipment (UE) may include receiving, from a base station (BS), a configured grant (CG) and transmitting, to a second UE based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

In an additional aspect of the disclosure, a method of communication performed by a user equipment (UE) may include receiving, from a wireless communications device, a configured grant (CG) and receiving, from a second UE, based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

In an additional aspect of the disclosure, a UE may include a transceiver, a memory, and a processor coupled to the transceiver and the memory, the UE may be configured to receive, from a base station (BS), a configured grant (CG) and transmit, to a second UE based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

In an additional aspect of the disclosure, a UE may include a transceiver, a memory, and a processor coupled to the transceiver and the memory, the UE may be configured to receive, from a wireless communications device, a configured grant (CG) and receive, from a second UE, based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

Other aspects, features, and instances of the present invention will become apparent to those of ordinary skill in the art, upon reviewing the following description of specific, exemplary instances of the present invention in conjunction with the accompanying figures. While features of the present invention may be discussed relative to certain aspects and figures below, all instances of the present invention can include one or more of the advantageous features discussed herein. In other words, while one or more instances may be discussed as having certain advantageous features, one or more of such features may also be used in accordance with the various instances of the invention discussed herein. In similar fashion, while exemplary aspects may be discussed below as device, system, or method instances it should be understood that such exemplary instances can be implemented in various devices, systems, and methods.

### BRIEF DESCRIPTION OF THE DRAWINGS

FIG. 1 illustrates a wireless communication network according to some aspects of the present disclosure.

FIG. 2 illustrates sidelink resources associated with a wireless communication network according to some aspects of the present disclosure.

FIG. 3 illustrates a slot partitioned into sub-slots according to some aspects of the present disclosure.

FIG. 4 illustrates sub-slot partitioning of a slot and a subsequent slot based on a configured grant according to some aspects of the present disclosure.

FIG. 5 illustrates sub-slot patterns based on a configured grant according to some aspects of the present disclosure.

FIG. 6 illustrates PSFCH resources mapped to sub-slots according to some aspects of the present disclosure.

FIG. 7 is a signaling diagram of a communication method according to some aspects of the present disclosure.

FIG. 8 is a block diagram of an exemplary user equipment (UE) according to some aspects of the present disclosure.

FIG. 9 is a block diagram of an exemplary base station (BS) according to some aspects of the present disclosure.

FIG. 10 is a flow diagram of a communication method according to some aspects of the present disclosure.

FIG. 11 is a flow diagram of a communication method according to some aspects of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

This disclosure relates generally to wireless communications systems, also referred to as wireless communications networks. In various instances, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks, as well as other communications networks. As described herein, the terms “networks” and “systems” may be used interchangeably.

An OFDMA network may implement a radio technology such as evolved UTRA (E-UTRA), Institute of Electrical and Electronic Engineers (IEEE) 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

In particular, 5G networks contemplate diverse deployments, diverse spectrum, and diverse services and devices that may be implemented using an OFDM-based unified, air interface. In order to achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

The 5G NR may be implemented to use optimized OFDM-based waveforms with scalable numerology and transmission time interval (TTI); having a common, flexible framework to efficiently multiplex services and features with a dynamic, low-latency time division duplex (TDD)/frequency division duplex (FDD) design; and with advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 5, 10, 20 MHz, and the like bandwidth (BW). For other various outdoor and small cell coverage deployments of TDD greater than 3 GHz, subcarrier spacing may occur with 30 kHz over 80/100 MHz BW. For other various indoor wideband implementations, using a TDD over the unlicensed portion of the 5 GHz band, the subcarrier spacing may occur with 60 kHz over a 160 MHz BW. Finally, for various deployments transmitting with mmWave components at a TDD of 28 GHz, subcarrier spacing may occur with 120 kHz over a 500 MHz BW.

The scalable numerology of the 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

Various other aspects and features of the disclosure are further described below. It should be apparent that the teachings herein may be embodied in a wide variety of forms and that any specific structure, function, or both being disclosed herein is merely representative and not limiting. Based on the teachings herein one of an ordinary level of skill in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. For example, a method may be implemented as part of a system, device, apparatus, and/or as instructions stored on a computer readable medium for execution on a processor or computer. Furthermore, an aspect may comprise at least one element of a claim.

The present application describes mechanisms for a UE to communicate transport blocks (TBs) to multiple UEs via sub-slots in a slot. The disclosed approaches include various methods of partitioning the sub-slots and configuring the resources for transmissions based on a configured grant (CG). The disclosed approaches further include various methods of transmitting the TBs to UEs that communicate using sidelink communications.

In some aspects of the present disclosure, the latency of wireless communications, including sidelink control and data communications, may be reduced by configuring the resources for a UE to transmit multiple TBs in sub-slots in a slot using a CG as compared to configuring the resources using second stage sidelink control information (SCI-2).

In accordance with the present disclosure configuring the resources for a UE to transmit multiple TBs in sub-slots using a CG may facilitate more efficient use and optimization of the frequency resources, lower UE power consumption, higher reliability of the wireless communications network, and reduced transmission latency. In this regard, wireless communication applications requiring low power and low latency such as vehicle-to-everything (V2X) and industrial Internet-of-Things (IoT) may benefit from the methods and devices of the present disclosure.

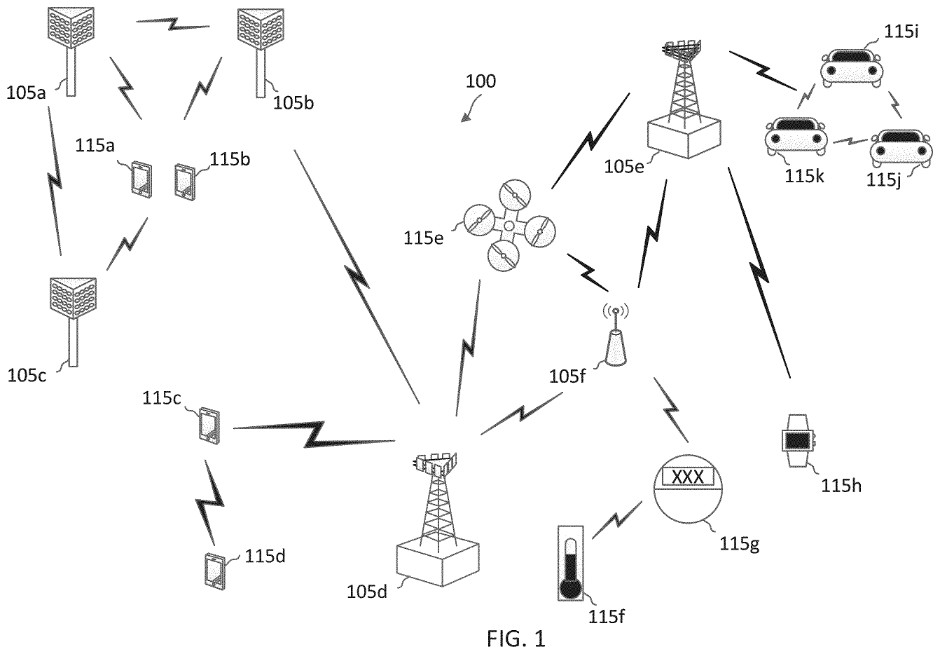

FIG. 1 illustrates a wireless communication network 100 according to some aspects of the present disclosure. The network 100 includes a number of base stations (BSs) 105 and other network entities. A BS 105 may be a station that communicates with UEs 115 and may also be referred to as an evolved node B (eNB), a next generation eNB (gNB), an access point, and the like. Each BS 105 may provide communication coverage for a particular geographic area. In 3GPP, the term “cell” can refer to this particular geographic coverage area of a BS 105 and/or a BS subsystem serving the coverage area, depending on the context in which the term is used.

A BS 105 may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A BS for a macro cell may be referred to as a macro BS. A BS for a small cell may be referred to as a small cell BS, a pico BS, a femto BS or a home BS. In the example shown in FIG. 1, the BSs 105d and 105e may be regular macro BSs, while the BSs 105a-105c may be macro BSs enabled with one of three dimension (3D), full dimension (FD), or massive MIMO. The BSs 105a-105c may take advantage of their higher dimension MIMO capabilities to exploit 3D beamforming in both elevation and azimuth beamforming to increase coverage and capacity. The BS 105f may be a small cell BS which may be a home node or portable access point. A BS 105 may support one or multiple (e.g., two, three, four, and the like) cells.

The network 100 may support synchronous or asynchronous operation. For synchronous operation, the BSs may have similar frame timing, and transmissions from different BSs may be approximately aligned in time. For asynchronous operation, the BSs may have different frame timing, and transmissions from different BSs may not be aligned in time.

The UEs 115 are dispersed throughout the wireless network 100, and each UE 115 may be stationary or mobile. A UE 115 may also be referred to as a terminal, a mobile station, a subscriber unit, a station, or the like. A UE 115 may be a cellular phone, a personal digital assistant (PDA), a wireless modem, a wireless communication device, a handheld device, a tablet computer, a laptop computer, a cordless phone, a wireless local loop (WLL) station, or the like. In one aspect, a UE 115 may be a device that includes a Universal Integrated Circuit Card (UICC). In another aspect, a UE may be a device that does not include a UICC. In some aspects, the UEs 115 that do not include UICCs may also be referred to as IoT devices or internet of everything (IoE) devices. The UEs 115a-115d are examples of mobile smart phone-type devices accessing network 100. A UE 115 may also be a machine specifically configured for connected communication, including machine type communication (MTC), enhanced MTC (eMTC), narrowband IoT (NB-IoT) and the like. The UEs 115e-115h are examples of various machines configured for communication that access the network 100. The UEs 115i-115k are examples of vehicles equipped with wireless communication devices configured for communication that access the network 100. A UE 115 may be able to communicate with any type of the BSs, whether macro BS, small cell, or the like. In FIG. 1, a lightning bolt (e.g., communication links) indicates wireless transmissions between a UE 115 and a serving BS 105, which is a BS designated to serve the UE 115 on the downlink (DL) and/or uplink (UL), desired transmission between BSs 105, backhaul transmissions between BSs, or sidelink transmissions between UEs 115.

In operation, the BSs 105a-105c may serve the UEs 115a and 115b using 3D beamforming and coordinated spatial techniques, such as coordinated multipoint (CoMP) or multi-connectivity. The macro BS 105d may perform backhaul communications with the BSs 105a-105c, as well as small cell, the BS 105f. The macro BS 105d may also transmits multicast services which are subscribed to and received by the UEs 115c and 115d. Such multicast services may include mobile television or stream video, or may include other services for providing community information, such as weather emergencies or alerts, such as Amber alerts or gray alerts.

The BSs 105 may also communicate with a core network. The core network may provide user authentication, access authorization, tracking, Internet Protocol (IP) connectivity, and other access, routing, or mobility functions. At least some of the BSs 105 (e.g., which may be an example of an evolved NodeB (eNB) or an access node controller (ANC)) may interface with the core network 130 through backhaul links (e.g., S1, S2, etc.) and may perform radio configuration and scheduling for communication with the UEs 115. In various examples, the BSs 105 may communicate, either directly or indirectly (e.g., through core network), with each other over backhaul links (e.g., X1, X2, etc.), which may be wired or wireless communication links.

The network 100 may also support mission critical communications with ultra-reliable and redundant links for mission critical devices, such as the UE 115e, which may be a vehicle (e.g., a car, a truck, a bus, an autonomous vehicle, an aircraft, a boat, etc.). Redundant communication links with the UE 115e may include links from the macro BSs 105d and 105e, as well as links from the small cell BS 105f. Other machine type devices, such as the UE 115f (e.g., a thermometer), the UE 115g (e.g., smart meter), and UE 115h (e.g., wearable device) may communicate through the network 100 either directly with BSs, such as the small cell BS 105f, and the macro BS 105e, or in multi-hop configurations by communicating with another user device which relays its information to the network, such as the UE 115f communicating temperature measurement information to the smart meter, the UE 115g, which is then reported to the network through the small cell BS 105f. The network 100 may also provide additional network efficiency through dynamic, low-latency TDD/FDD communications, such as vehicle-to-vehicle (V2V), vehicle-to-everything (V2X), cellular-vehicle-to-everything (C-V2X) communications between a UE 115i, 115j, or 115k and other UEs 115, and/or vehicle-to-infrastructure (V2I) communications between a UE 115i, 115j, or 115k and a BS 105.

In some implementations, the network 100 utilizes OFDM-based waveforms for communications. An OFDM-based system may partition the system BW into multiple (K) orthogonal subcarriers, which are also commonly referred to as subcarriers, tones, bins, or the like. Each subcarrier may be modulated with data. In some instances, the subcarrier spacing between adjacent subcarriers may be fixed, and the total number of subcarriers (K) may be dependent on the system BW. The system BW may also be partitioned into subbands. In other instances, the subcarrier spacing and/or the duration of TTIs may be scalable.

In some instances, the BSs 105 can assign or schedule transmission resources (e.g., in the form of time-frequency resource blocks (RB)) for downlink (DL) and uplink (UL) transmissions in the network 100. DL refers to the transmission direction from a BS 105 to a UE 115, whereas UL refers to the transmission direction from a UE 115 to a BS 105. The communication can be in the form of radio frames. A radio frame may be divided into a plurality of subframes, for example, about 10. Each subframe can be divided into slots, for example, about 2. Each slot may be further divided into mini-slots. In a FDD mode, simultaneous UL and DL transmissions may occur in different frequency bands. For example, each subframe includes a UL subframe in a UL frequency band and a DL subframe in a DL frequency band. In a TDD mode, UL and DL transmissions occur at different time periods using the same frequency band. For example, a subset of the subframes (e.g., DL subframes) in a radio frame may be used for DL transmissions and another subset of the subframes (e.g., UL subframes) in the radio frame may be used for UL transmissions.

The DL subframes and the UL subframes can be further divided into several regions. For example, each DL or UL subframe may have pre-defined regions for transmissions of reference signals, control information, and data. Reference signals are predetermined signals that facilitate the communications between the BSs 105 and the UEs 115. For example, a reference signal can have a particular pilot pattern or structure, where pilot tones may span across an operational BW or frequency band, each positioned at a pre-defined time and a pre-defined frequency. For example, a BS 105 may transmit cell specific reference signals (CRSs) and/or channel state information—reference signals (CSI-RSs) to enable a UE 115 to estimate a DL channel. Similarly, a UE 115 may transmit sounding reference signals (SRSs) to enable a BS 105 to estimate a UL channel Control information may include resource assignments and protocol controls. Data may include protocol data and/or operational data. In some instances, the BSs 105 and the UEs 115 may communicate using self-contained subframes. A self-contained subframe may include a portion for DL communication and a portion for UL communication. A self-contained subframe can be DL-centric or UL-centric. A DL-centric subframe may include a longer duration for DL communication than for UL communication. A UL-centric subframe may include a longer duration for UL communication than for UL communication.

In some instances, the network 100 may be an NR network deployed over a licensed spectrum. The BSs 105 can transmit synchronization signals (e.g., including a primary synchronization signal (PSS) and a secondary synchronization signal (SSS)) in the network 100 to facilitate synchronization. The BSs 105 can broadcast system information associated with the network 100 (e.g., including a master information block (MIB), remaining minimum system information (RMSI), and other system information (OSI)) to facilitate initial network access. In some instances, the BSs 105 may broadcast the PSS, the SSS, and/or the MIB in the form of synchronization signal blocks (SSBs) over a physical broadcast channel (PBCH) and may broadcast the RMSI and/or the OSI over a physical downlink shared channel (PDSCH).

In some instances, a UE 115 attempting to access the network 100 may perform an initial cell search by detecting a PSS from a BS 105. The PSS may enable synchronization of period timing and may indicate a physical layer identity value. The UE 115 may then receive a SSS. The SSS may enable radio frame synchronization, and may provide a cell identity value, which may be combined with the physical layer identity value to identify the cell. The SSS may also enable detection of a duplexing mode and a cyclic prefix length. The PSS and the SSS may be located in a central portion of a carrier or any suitable frequencies within the carrier.

After receiving the PSS and SSS, the UE 115 may receive a MIB. The MIB may include system information for initial network access and scheduling information for RMSI and/or OSI. After decoding the MIB, the UE 115 may receive RMSI and/or OSI. The RMSI and/or OSI may include radio resource control (RRC) information related to random access channel (RACH) procedures, paging, control resource set (CORESET) for physical downlink control channel (PDCCH) monitoring, physical uplink control channel (PUCCH), physical uplink shared channel (PUSCH), power control, SRS, and cell barring.

After obtaining the MIB, the RMSI and/or the OSI, the UE 115 can perform a random access procedure to establish a connection with the BS 105. For the random access procedure, the UE 115 may transmit a random access preamble and the BS 105 may respond with a random access response. Upon receiving the random access response, the UE 115 may transmit a connection request to the BS 105 and the BS 105 may respond with a connection response (e.g., contention resolution message).

After establishing a connection, the UE 115 and the BS 105 can enter a normal operation stage, where operational data may be exchanged. For example, the BS 105 may schedule the UE 115 for UL and/or DL communications. The BS 105 may transmit UL and/or DL scheduling grants to the UE 115 via a PDCCH. The BS 105 may transmit a DL communication signal to the UE 115 via a PDSCH according to a DL scheduling grant. The UE 115 may transmit a UL communication signal to the BS 105 via a PUSCH and/or PUCCH according to a UL scheduling grant.

In some aspects, the UE 115g (e.g., a meter, a programmable logic controller, an IoT device, a robot, a vehicle, a smartphone, etc.) may map a sub-PSCCH, a sub-PSSCH, sidelink control information (SCI), and an automatic gain control (AGC) symbol to a sub-slot of a plurality of sub-slots of a slot. In some aspects, the network (e.g., the network 100 or 200) may include a mix of both UEs that support the sub-slot structure (e.g., the sub-slot-based UEs 115) and legacy UEs that do not support the sub-slot structure, but support the slot structure (e.g., the slot-based UEs 115).

The UE (e.g., the UE 115 or the UE 800) may receive, from a base station (BS) (e.g., the BS 105 or the BS 900), a configured grant (CG). In this regard, the UE 115 may receive the CG from the BS 105 in an RRC configuration message, a DCI message, and/or a MAC control element signaling via a physical downlink shared channel (PDSCH), a physical downlink control channel (PDCCH), or other suitable channel. In some instances, the CG may allow the UE 115 to transmit transport blocks (TBs) to other UEs 115 without requiring the UE 115 to request resources from the BS 105 on a dynamic basis. Accordingly, the UE 115 may perform sidelink communications with other UEs 115 based on the CG received from the BS 105.

By receiving the resource configuration information via the CG and eliminating the SCI-2, the UEs 115 may reduce computing resources and/or power consumption as compared to receiving the resource configuration information via the SCI-2. For example, the UE 115 may reduce overhead and power consumption by not performing blind decoding on the SCI-2. In some aspects, the UE 115 may receive the CG from the BS 105 and transmit the CG to another UE 115. For example, when the other UE 115 is out of range of the BS, the UE 115 may forward the CG to the other UE 115.

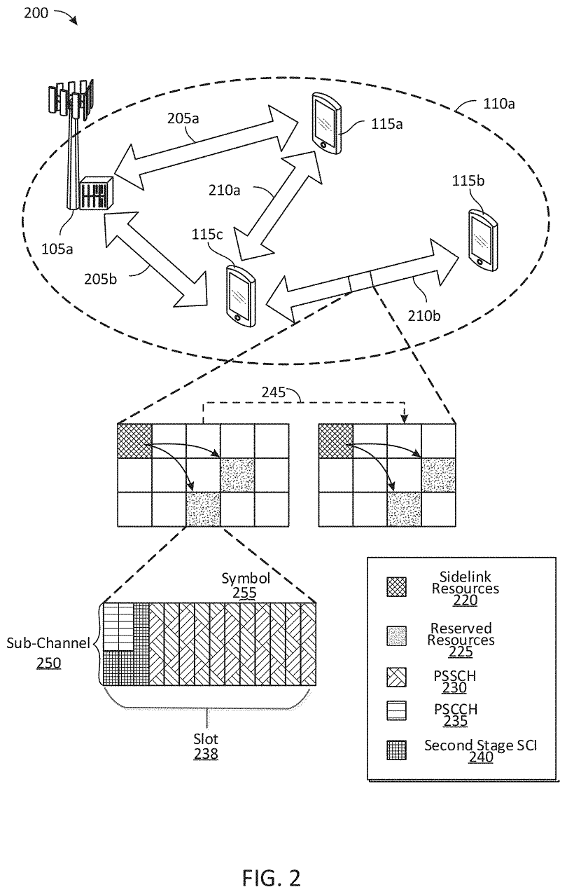

FIG. 2 illustrates sidelink resources associated with a wireless communication network 200 according to some aspects of the present disclosure. The wireless communications network 200 may include a base station 105a and UEs 115a, 115b, and 115c, which may be examples of a BS 105 and a UE 115 as described with reference to FIG. 1. Base station 105a and UEs 115a and 115c may communicate within geographic coverage area 110a and via communication links 205a and 205b, respectively. UE 115c may communicate with UEs 115a and 115b via sidelink communication links 210a and 210b, respectively. In some examples, UE 115c may transmit SCI to UEs 115a and 115b via the sidelink control resources 220. The SCI may include an indication of resources reserved for retransmissions by UE 115c (e.g., the reserved resources 225). In some examples, UEs 115a and 115b may determine to reuse one or more of the reserved resources 225.

In some aspects, a device in the wireless communication network 200 (e.g., a UE 115, a BS 105, or some other node) may convey SCI to another device (e.g., another UE 115, a BS 105, sidelink device or vehicle-to-everything (V2X) device, or other node). The SCI may be conveyed in one or more stages. The first stage SCI may be carried on the PSCCH while the second stage SCI may be carried on the corresponding PSSCH. For example, UE 115c may transmit a PSCCH/first stage SCI 235 (e.g., SCI-1) to each sidelink UE 115 in the network (e.g., UEs 115a and 115b) via the sidelink communication links 210. The PSCCH/first stage SCI-1 235 may indicate resources that are reserved by UE 115c for retransmissions (e.g., the SCI-1 may indicate the reserved resources 225 for retransmissions). Each sidelink UE 115 may decode the first stage SCI-1 to determine where the reserved resources 225 are located (e.g., to refrain from using resources that are reserved for another sidelink transmission and/or to reduce resource collision within the wireless communications network 200). Sidelink communication may include a mode 1 operation in which the UEs 115 are in a coverage area of BS 105a. In mode 1, the UEs 115 may receive a configured grant from the BS 105a that defines parameters for the UEs 115 to access the channel Sidelink communication may also include a mode 2 operation in which the UEs 115 operate autonomously from the BS 105a and perform sensing of the channel to gain access to the channel. In some aspects, during mode 2 sidelink operations, the sidelink UEs 115 may perform channel sensing to locate resources reserved by other sidelink transmissions. The first stage SCI-1 may reduce the need for sensing each channel. For example, the first stage SCI-1 may include an explicit indication such that the UEs 115 may refrain from blindly decoding each channel. The first stage SCI-1 may be transmitted via the sidelink control resources 220. The sidelink control resources 220 may be configured resources (e.g., time resources or frequency resources) transmitted via a PSCCH 235. In some examples, the PSCCH 235 may be configured to occupy a number of physical resource blocks (PRBs) within a selected frequency. The frequency may include a single subchannel 250 (e.g., 10, 12, 15, 20, 25, or some other number of RBs within the subchannel 250). The time duration of the PSCCH 235 may be configured by the BS 105a (e.g., the PSCCH 235 may span 1, 2, 3, or some other number of symbols 255).

The first stage SCI-1 may include one or more fields to indicate a location of the reserved resources 225. For example, the first stage SCI-1 may include, without limitation, one or more fields to convey a frequency domain resource allocation (FDRA), a time domain resource allocation (TDRA), a resource reservation period 245 (e.g., a period for repeating the SCI transmission and the corresponding reserved resources 225), a modulation and coding scheme (MCS) for a second stage SCI-2 240, a beta offset value for the second stage SCI-2 240, a DMRS port (e.g., one bit indicating a number of data layers), a physical sidelink feedback channel (PSFCH) overhead indicator, a priority, one or more additional reserved bits, or a combination thereof. The beta offset may indicate the coding rate for transmitting the second stage SCI-2 240. The beta offset may indicate an offset to the MCS index. The MCS may be indicated by an index ranging from 0 to 31. For example, if the MCS is set at index 16 indicating a modulation order of 4 and a coding rate of 378, the beta offset may indicate a value of 2 thereby setting the coding rate to 490 based on an MCS index of 18. In some examples, the FDRA may be a number of bits in the first stage SCI-1 that may indicate a number of slots and a number of subchannels reserved for the reserved resources 225 (e.g., a receiving UE 115 may determine a location of the reserved resources 225 based on the FDRA by using the subchannel 250 including the PSCCH 235 and first stage SCI-1 as a reference). The TDRA may be a number of bits in the first stage SCI-1 (e.g., 5 bits, 9 bits, or some other number of bits) that may indicate a number of time resources reserved for the reserved resources 225. In this regard, the first stage SCI-1 may indicate the reserved resources 225 to the one or more sidelink UEs 115 in the wireless communication network 200.

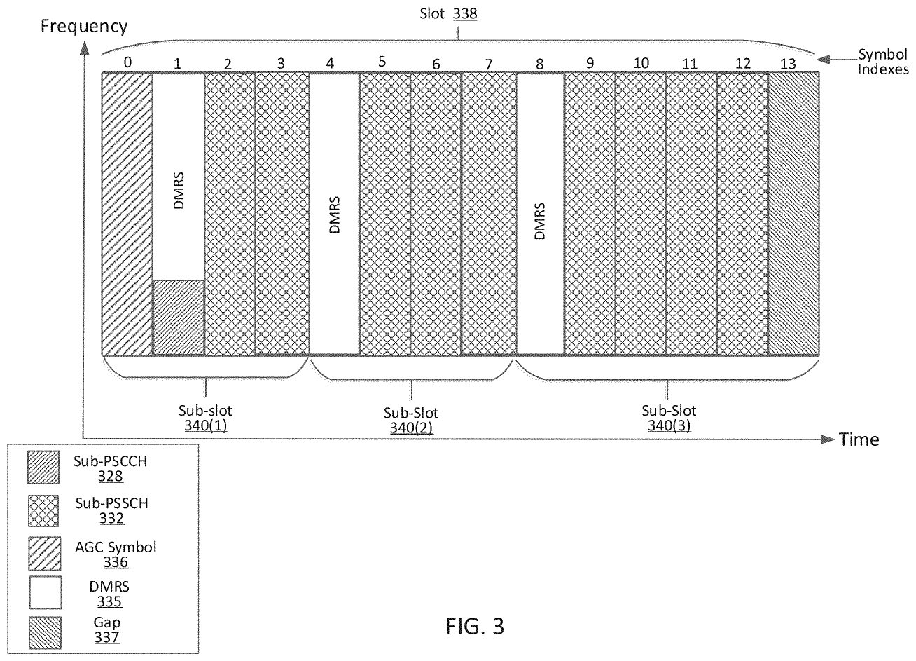

The sidelink UEs 115 may attempt to decode the reserved resources 225 indicated by the first stage SCI-1. In some aspects, the reserved resources 225 may be used for retransmission of sidelink data or the first stage SCI-1. Additionally or alternatively, the reserved resources 225 may include resources for sidelink transmissions, such as a PSSCH 230. As will be described in detail below with reference to FIGS. 3-6, the slot 238 may be partitioned into multiple sub-slots. The sub-slots may be transmitted via a sub-PSSCH using one or more symbols 255. In some examples, the PSSCH 230 may be transmitted via one or more time or frequency resources via one or more full or partial symbols 255. A second stage SCI-2 240 may be transmitted via one or more symbols 255 of the PSSCH 230. The second stage SCI-2 240 may be transmitted in a symbol(s) near or at the beginning of a slot. The second stage SCI-2 240 may include an indication of which of the reserved resources 225 the transmitting UE 115 may use for sidelink transmissions. The second stage SCI-2 240 may thereby be received and decoded by sidelink UEs 115 intended to receive and decode the corresponding sidelink communications. Additionally or alternatively, the UE 115 may receive a configuration indicating the parameters and resources required for sidelink communications via a CG instead of the SCI-2. By receiving the configuration parameters and resources via the CG and eliminating the SCI-2, the UEs 115 may reduce computing resources and/or power consumption as compared to receiving the information via the SCI-2. For example, the UEs 115 may reduce power consumption by not performing blind decoding on the SCI-2. In some aspects, the UE 115c may receive the CG from the BS 105a and transmit the CG to another UE 115. For example, when the other UE 115b is out of range of the BS 105a, the UE 115c may forward the CG to the UE 115b.

FIG. 3 illustrates a slot 338 partitioned into sub-slots 340 according to some aspects of the present disclosure. In FIG. 3, the x-axis represents time in some arbitrary units and the Y-axis represents frequency in some arbitrary units. In some aspects, the UE (e.g., the UE 115, the UE 800) may map a sub-PSCCH 328, a sub-PSSCH 332, an AGC symbol 336, a DMRS 335, and a gap symbol 337 to any or all of the sub-slots 340 in a slot 338. The UE 115 may map multiple sub-PSCCHs 328, sub-PSSCHs 332, AGC symbols 336, DMRSs 335, and gap symbols 337 to multiple sub-slots 340 within the slot 338. In some instances, each of the sub-PSSCHs 332 mapped in the sub-slot 340 may be used by the UE 115 to transmit TBs to different UEs 115 over a sidelink channel. In this manner, the UE 115 may increase the utilization of time/frequency resources within the slot 338 as compared to the UE 115 transmitting a single TB to a single UE 115 in the slot 338.

By partitioning the slot 338 into the plurality of sub-slots 340, each sub-slot 340(1) . . . 340(3) may be utilized by the UE 115 to transmit a TB, facilitating the transmission of multiple TBs by the UE 115 in a single slot 338. In some instances, the UE 115 may receive a sub-slot partitioning configuration from a BS (e.g., the BS 105 or BS 900). The UE 115 may receive a resource pool (RP) configuration from the BS 105 that defines the RP for the sub-slots 340. In this regard, the UE 115 may receive the sub-slot 340 and/or RP configurations as a CG in an RRC message and/or a DCI message (e.g., a DCI-3 signal, DCI-1 signal). The UE 115 may partition the slot 338 into a plurality of sub-slots 340 based on the sub-slot configuration and/or the RP configuration. The UE 115 may transmit the sub-slot structure in the CG to other UEs 115 (e.g., receiving UEs 115). In some instances, the UE 115 communicates the CG to the other UEs 115 in a first stage SCI-1. Additionally or alternative, the UE 115 may receive the CG directly from the BS 105.

In some aspects, the UE 115 may partition the slot 338 such that each sub-slot 340 occupies multiple symbols within the slot 338. For example, a slot 338 may include 2, 3, 4, or more sub-slots. In some instances, a slot may include 14 symbols. A sub-slot 340 may occupy 2, 3, 4, 5, 6, or more symbols. In some aspects, each sub-slot 340 may occupy contiguous symbols within the slot 338. In this regard, each sub-slot 340 may occupy groups of symbols that are contiguous in time. The group of contiguous symbols may include any number of symbols contained within the slot 338. Referring to FIG. 3, the sub-slot 340(1) may occupy symbol indexes 0-3. The sub-slot 340(2) may occupy symbol indexes 4-7. The sub-slot 340(3) may occupy symbol indexes 8-13, or any other group of contiguous symbols within the slot 338. The number of symbols occupying the sub-slot 340 may be based on the size of the TB to be transmitted. A larger TB may require more symbols than a smaller TB.

In some aspects, the UE 115 may map an AGC symbol 336 to each sub-slot 340 of the slot 338. Another UE 115 may receive a TB from the UE 115 in a sub-PSSCH 332 whose signal strength may vary over a wide dynamic range depending on channel attenuation, interference, and/or other conditions. The AGC symbol 336 may be used to adjust the strength of the received signal in order to reduce the quantization error at the analog-to-digital converter of the receiving UE 115. In some instances, the AGC symbol 336 may help a receiving UE 115 adjust the gain of a front-end amplifier of a receiver. In some aspects, the UE 115 may map the AGC symbol 336 to the leading (e.g., the earliest in time) symbol 0 in the earliest sub-slot 340(1) of the plurality of sub-slots 340(1) . . . 340(3) in the slot 338. The UE 115 may map the AGC symbol 336 to the leading symbol 0 in order for a receiving UE 115 to set the gain of the amplifier and successfully decode the subsequent symbols of the sub-slot 340. In some aspects, the UE 115 may map the AGC symbol 336 to only the leading symbol 0 of the leading sub-slot 340(1) as shown in FIG. 3. The UE 115 may refrain from mapping the AGC symbol 336 to the non-leading sub-slots 340(2) and 340(3) in order for the receiving UEs 115 to set the gain of an amplifier based on the AGC symbol 336 in the leading sub-slot 340(1) and successfully decode the subsequent symbols of the subsequent sub-slots 340(2) and 340(3). In some aspects, omitting the AGC symbol 336 in the non-leading sub-slots 340(2) and 340(3) (e.g., the subsequent sub-slots) may enable the UE 115 to map an additional symbol to a sub-PSSCH 332 in the non-leading sub-slots 340(2) and 340(3), enabling larger TBs to be transmitted in the non-leading sub-slots 340(2) and 340(3).

In some aspects, the UE 115 may map a sub-PSSCH 332 to each sub-slot 340 of the slot 338. Each sub-PSSCH 332 of each sub-slot 340 may occupy one or more symbols. The sub-PSSCHs 332 may carry one or more TBs that include the data to be communicated by a transmitting UE 115. The number of symbols the sub-PSSCH 332 occupies may be based on the size of the TB. As described above, in accordance with the present disclosure, each sub-slot 340 may be utilized by the UE 115 to transmit the TB(s).

In some aspects, the UE 115 may map a gap symbol 337 (e.g., a guard period) to the last symbol (e.g., symbol index 13) of the last sub-slot 340(3) of the plurality of sub-slots 340(1) . . . 340(3). The gap symbol 337 may be used by UEs 115 for timing adjustments and/or switching between transmitting and receiving.

In some aspects, the UE 115 may map a sub-PSCCH 328 to carry a first stage SCI-1 in one or more sub-slots 340 of the slot 338. The UE may refrain from mapping a second stage SCI-2 to one or more sub-slots 340. The UE 115 may decode the first-stage SCI-1 for channel sensing purposes and to determine the resources reserved by other transmissions. The CG may provide additional control information that allows the UE 115 to receive and decode a transmission. In this regard, the UE 115 may transmit the CG to another UE 115 in the sub-PSCCH 328. The SCI-1 may include resource assignments for at least one sub-slot 340 of the plurality of sub-slots 340(1) . . . 340(3) of a slot 338 and/or resource assignments for at least one sub-slot 340 of another slot (e.g., a future slot). The resource assignments for the current slot 338 or for a future slot may be used by transmitting UE(s) 115 for retransmissions of TB(s) that are not successfully decoded by receiving UE(s) 115. The UEs 115 may be operating in a sidelink mode 1 in which the UE 115 receives the resource assignments in the CG from a serving BS (e.g., the BS 105 or BS 900). The UE 115 may transmit the resource assignments in the CG to other UEs 115 in the SCI-1 carried by the sub-PSCCH 328.

In some aspects, the UE 115 may transmit a sub-PSSCH 332 in a sub-slot 340 that includes at least one demodulation reference signal (DMRS) 335. The DMRS 335 may be a reference signal used by a receiving UE 115 for channel estimation and/or compensating for Doppler effects. The CG may include a configuration for the DMRS 335 associated with the plurality of sub-slots 340. The DMRS 335 may be included in at least one sub-slot 340 of the plurality of sub-slots 340(1) . . . 340(3) of the slot 338. In this regard, the DMRS 335 may be located anywhere within the sub-slot 340. For example, the DMRS may be located in the first symbol of the sub-slot, the last symbol of the sub-slot, or an intermediate symbol of the sub-slot. In some aspects, the DMRS 335 may include all resource elements (REs) within the symbol. In some aspects, the DMRS 335 may include a portion of the REs, but less than all of the REs within the symbol. The transmitting UE 115 may transmit the DMRS 335 based on the CG. The DMRS 335 configuration in the CG may include the number of DMRSs 335 in the slot 338 and the time/frequency resources associated with the DMRS 335. The receiving UE 115 may monitor for the DMRS 335 to estimate the channel in the time/frequency resources indicated in the CG. By including the DMRS 335 configuration in the CG, the UE 115 may monitor the time/frequency resources indicated in the CG for the DMRS 335 and refrain from blind decoding for the DMRS 335. Refraining from blind decoding for the DMRS 335 may reduce power consumption in the UE 115.

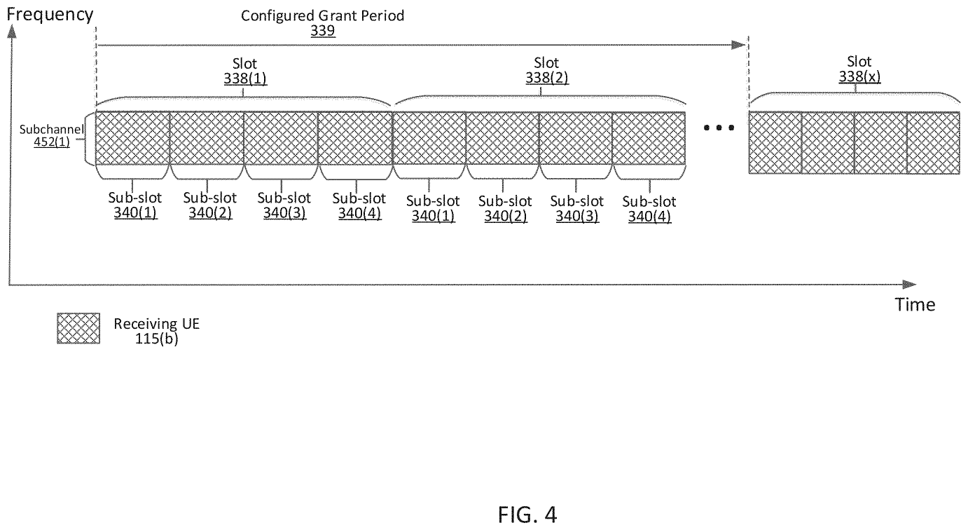

FIG. 4 illustrates a sub-slot 340 partitioning of a slot 338(1) and a subsequent slot 338(2) based on a configured grant period 339 according to some aspects of the present disclosure. In FIG. 4, the x-axis represents time in some arbitrary units and the Y-axis represents frequency in some arbitrary units. The UE (e.g., the UE 115, the UE 800) may map sub-slots 340(1) . . . 340(4) in a slot 338(1) and a subsequent slot 338(2) based on the CG. In some instances, the CG may allow the UE 115 to transmit TBs to other UEs 115 without requiring the UE 115 to request resources from the BS 105 on a dynamic basis. Accordingly, the UE 115 may perform sidelink communications with other UEs 115 based on the CG received from the BS 105.

The CG may provide the UE 115 with resources to use in transmitting a TB and/or one or more retransmissions (e.g., 1, 2, or other number of retransmissions). Nearby UEs 115 operating in sidelink mode 2 may know which resources UEs 115 in sidelink mode 1 will utilize. One or more nearby UEs 115 may receive the CG that informs the UE 115 as to which resources are used by other UEs 115. The one or more nearby UEs 115 may receive the CG from another UE 115 and/or receive the CG from a BS 105. Each UE 115 may decode the CG to determine where the reserved resources are located (e.g., in order to refrain from using resources that are reserved for another sidelink transmission and/or to reduce resource collision within the wireless communications network). The BS 105 may allocate the CG resources to multiple UEs 115, each UE 115 of the multiple UEs 115 may utilize the resources of the CG when they have data to transmit to another UE 115 and/or to a BS. In some aspects, the BS 105 may allocate a pool of resources that may be shared among the UEs 115. The UEs 115 may select resources from the shared pool of resources when they have data to transmit to another UE 115 and/or to a BS 105.

In some aspects, the BS 105 may dedicate (e.g., reserve) resources to each of the UEs 115. The dedicated resources may be used exclusively by the UEs 115. Each UE 115 may select resources from the dedicated resources assigned to the respective UE 115 when they have data to transmit to another UE 115 and/or to a BS 105. By assigning the CG resources, the wireless network eliminates the packet transmission delay for a scheduling request procedure and increases the utilization ratio of allocated periodic radio resources. The CG may reduce the delay caused by the dynamic scheduling request procedure by pre-allocating sidelink radio resources for use by UEs 115 for sidelink communications. For example, the UE 115 may receive a CG with one or more sub-slot 340 resources (e.g., one, two, three, or other number of slot resources) in a CG period. In some instances, the BS 105 assigns a set of sidelink resources to a UE 115 for each sub-slot 340 of each slot 338 up to the slot limit of the CG. In some aspects, the CG may be limited to a number of slots. For example, the CG may be limited to 1, 2, 3, or more slots 338. In the example of FIG. 3, configured grant period 339 includes slots 338(1) and 338(2). In some aspects, the UE 115 may transmit a message to the BS 105 indicating information about the expected data traffic, including one or more of a periodicity of TBs, a TB maximum size, and/or QoS information. In some instances, the QoS information may include the latency budget and/or reliability required by the TBs and/or the priority of the TBs. This information may be used by the BS 105 to create, configure, and/or allocate the CG to the UE 115 in a manner that satisfies the requirements of the data traffic of the UE 115. The CG may be configured using a set of parameters that includes the CG index, the time-frequency resource allocation for the sub-slots 340, and/or a configured grant period 339 of the allocated resources.

In some instances, the CG allows for periodic transmissions by the UE without a dynamic grant. Sidelink mode 1 defines two types of CG schemes: CG type 1 and CG type 2. In both CG type 1 and CG type 2, the CG may be configured using RRC signaling. CG type 1 may be utilized by the UE immediately after receiving the CG until it is released by the BS 105. In CG type 1, the CG may be activated/deactivated by the BS 105 using RRC signaling. The UE 115 may use a CG type 2 only after it is activated by the BS 105 and until it is deactivated by the BS 105. In this regard, the UE 115 may receive, from the BS 105 an activation/deactivation message via DCI signaling. With CG type 2, a BS 105 may configure multiple CGs for a UE 115 and only activate a subset of the CGs based on the UE 115 needs. Resources in non-active CGs of a UE 115 may be allocated to other UEs 115.

In some aspects, the CG may configure and/or include parameters that may be carried by a second-stage sidelink control information (SCI-2). For example, the CG may include time and frequency resources associated with a plurality of sub-slots 340 of a slot 338. The CG may include a modulation and coding scheme (MCS) associated with the plurality of sub-slots 340(1) . . . 340(4). The MCS may include the modulation format and/or coding rate applied to the sub-PSSCHs associated with the sub-slots 340. The MCS may be used by one or more receiving UEs 115 to decode transmissions received from a transmitting UE 115. The CG may include one or more UE 115 identifiers to indicate the UE(s) 115 associated with the CG. The CG may include the transport block size (TBS). The transport block size may be based on the modulation order, the code rate, and/or the number of physical resource blocks (PRBs) used. The CG may include a sub-slot pattern that indicates which sub-slots 340 may be used to periodically transmit to a particular receiving UE 115. For example, the sub-slot pattern may indicate one or more sub-slots 340 (e.g., 1, 2, 3, 4, etc., including all of the sub-slots) in the slot 338 that are assigned to a particular receiving UE 115. In some instances, the sub-slot pattern may indicate every second sub-slot in the slot is assigned to a particular UE 115. In some instances, the sub-slot pattern may indicate every third sub-slot in the slot is assigned to a particular UE 115. Any suitable sub-slot pattern may be utilized. Referring to the example of FIG. 4, the sub-slot pattern indicates that all of the sub-slots 340(1), 340(2), 340(3), and 340(4) in the slots 338(1) and 338(2) are assigned to receiving UE 115(b). The CG may indicate the sub-slot pattern for each slot for the configured grant period 339 (e.g. slots 338(1) and 338(2)). For the subsequent configured grant period 339 that includes slot 338(x), the sub-slot pattern may remain the same or change based on the CG associated with the particular configured grant period 339.

Additionally or alternatively, the UE 115 may receive, from the BS 105, a plurality of CGs associated with a plurality of sub-slots 340. In this regard, the UE 115 may receive the plurality of CGs from the BS 105 using RRC signaling. Each of the CGs of the plurality of CGs may be identified by a CG identifier. For example, the CG identifier may include a CG index. In some aspects, each sub-slot 340 of the plurality of sub-slots 340(1) . . . 340(4) may be assigned a CG. For example, each of the four sub-slots 340(1) . . . 340(4) of slots 338(1) and 338(2) may each have an associated CG. In some instances, a CG may cover multiple sub-slots 340 of the plurality of sub-slots 340(1) . . . 340(4). Each of the CGs may be distinguished from one another by an index associated with the individual CG. The CG index may be a value corresponding to a sub-slot index, a slot number, a sequence frame number, and/or a combination thereof. In some aspects, the UE 115 may receive a message from the BS 105 indicating which CG(s) of the plurality of CGs the UE 115 may use. In this regard, the UE 115 may receive the message from the BS 105 indicating the CG(s) available for use by the UE 115 via an RRC message and/or a downlink control information (DCI) message (e.g., a unicast DCI3 message and/or a groupcast DCI3 message).

In some aspects, the UE 115 may transmit padding in at least one sub-slot 340 of the plurality of sub-slots 340(1) . . . 340(4). For example, the UE 115 may transmit a TB that includes padding in at least one sub-slot 340. The padding may include random data. The padding may be transmitted by the UE 115 without a particular UE 115 destination ID. In some aspects, the padding may be transmitted in the last sub-slot 340(4) of the plurality of sub-slots 340(1) . . . 340(4) of the slot 338. For example, in some instances, the UE 115 may transmit a TB in a leading sub-slot 340(1) and transmit padding in one or more subsequent sub-slots 340 up to a border between the last sub-slot 340(4) of the slot 338(1) and a subsequent slot 338(2). In some aspects, the network (e.g., the network 100 or 200) may include a mix of both UEs 115 that support the sub-slot structure and legacy UEs 115 that do not support the sub-slot structure, but support the slot structure. In this case of mixed UEs 115, a sub-slot-based UE 115 may transmit padding in at least one sub-slot 340 to reduce interference effects on legacy slot-based UEs 115 that receive TBs based on the slot structure. This may facilitate the legacy UEs 115 to maintain proper gain setting of a receiver of the legacy UEs 115.

In some aspects, the UE 115 may transmit the TB in a sub-PSSCH associated with a sub-slot 340 of the plurality of sub-slots 340(1) . . . 340(4). The CG may include information for mapping the sub-PSSCH to one or more sub-slots 340 of the plurality of sub-slots 340(1) . . . 340(4). In some aspects, the UE 115 may refrain from transmitting a second stage sidelink control information (SCI-2) during the sub-slot 340 mapped with a sub-PSSCH. The SCI-2 may include information such as the MCS for the sub-PSSCH, the TBS, sub-slot pattern for the plurality of sub-slots, the DMRS configuration, and/or the HARQ process ID. Aspects of the present disclosure may eliminate the need for the SCI-2 by including the information carried by the SCI-2 in the CG. By receiving the information via the CG and eliminating the SCI-2, the UEs 115 may reduce computing resources and/or power consumption as compared to receiving the information via the SCI-2. For example, the UE 115 may reduce power consumption by not performing blind decoding on the SCI-2. In some aspects, the UE 115 may receive the CG from the BS 105 and transmit the CG to another UE 115. For example, when the other UE 115 is out of range of the BS 105, the UE 115 may forward the CG to the other UE 115.

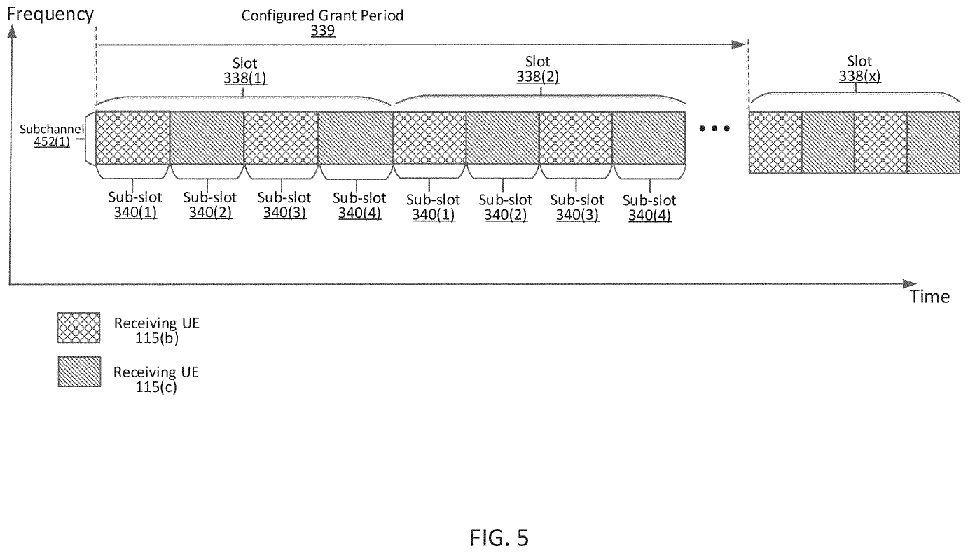

FIG. 5 illustrates sub-slot patterns based on a configured grant according to some aspects of the present disclosure. In FIG. 5, the x-axis represents time in some arbitrary units and the Y-axis represents frequency in some arbitrary units. In FIG. 5, slots 338(1) and 338(2) are shown partitioned into sub-slots 340 based on a CG. The UE (e.g., the UE 115, the UE 800) may map sub-slots 340(1) . . . 340(4) in a slot 338(1) and a subsequent slot 338(2) based on the CG. In some instances, the CG may allow the UE 115 to transmit TBs to other UEs 115 without requiring the UE 115 to request resources from the BS 105 on a dynamic basis. Accordingly, the UE 115 may perform sidelink communications with other UEs 115 based on the CG received from the BS 105.

FIG. 5 shows a similar sub-slot structure as FIG. 4. However, the sub-slot pattern in FIG. 5 differs from the sub-slot pattern of FIG. 4. Referring to the example of FIG. 4, the sub-slot pattern indicates that all of the sub-slots 340(1), 340(2), 340(3), and 340(4) in the slots 338(1) and 338(2) are assigned to receiving UE 115(b). Referring to the example of FIG. 5, the sub-slot pattern indicates that sub-slots 340(1) and 340(3) in the slots 338(1) and 338(2) are assigned to receiving UE 115(b), while the sub-slots 340(2) and 340(4) in the slots 338(1) and 338(2) are assigned to receiving UE 115(c).

In some aspects, the UE 115 may transmit a TB to a receiving UE 115(b) in a subset of sub-slots that includes sub-slots 340(1) and 340(3) of the slots 338(1) and 338(2). The UE 115 may also transmit a TB to receiving UE 115(c) in a second subset of sub-slots that includes sub-slots 340(2) and 340(4). The second subset of sub-slots 340(2) and 340(4) may be different from the first subset of sub-slots 340(1) and 340(3). The UE 115 may transmit different TBs to different UEs 115 within the different subsets of sub-slots 340. In some aspects, the UE 115 may transmit different TBs to different UEs 115 within the subsets of sub-slots 340 on a periodic basis. In this regard, the periodic basis may be based on a pattern associated with the sub-slots. The CG may include the sub-slot pattern to facilitate the periodic transmission. For example, slots 338(1) and 338(2) may each include 4 sub-slots 340(1), 340(2), 340(3), and 340(4). The UE 115 may transmit TBs to the receiving UE 115(b) in a sub-slot pattern that includes the first and third sub-slots 340(1) and 340(3) and transmit TBs to the receiving UE 115(c) in a sub-slot pattern that includes the second and fourth sub-slots 340(2) and 340(4). The UE 115 may periodically repeat the transmissions using the sub-slot pattern for each slot 338 of the CG period 339. The CG period 339 may include 2, 3, 4, or more slots 338. The UE 115 may transmit any number of TBs to any number of UEs 115 using a repeating sub-slot pattern.

Additionally or alternatively, the CG may assign a sub-PSSCH associated with a sub-slot 340 to multiple receiving UEs 115(b) and 115(c). In this regard, the CG may assign the same sub-PSSCH to multiple receiving UEs 115(b) and 115(c). For example, the CG may assign the same sub-PSSCH (e.g., the same set of symbols belonging to the sub-PSSCH in a sub-slot 340) to receiving UEs 115(b) and 115(c). The CG may assign this same sub-PSSCH to a transmitting UE 115 for transmitting to receiving UEs 115(b) and 115(c). The transmitting UE 115 may transmit to either the receiving UE 115(b) or the receiving UE 115(c) via the same sub-PSSCH in the sub-slot 340. For example, during sub-slot 340(1) of slot 338(1) of CG period 339, the UE 115 may transmit to the receiving UE 115(b) via the common sub-PSSCH of the sub-slot 340(1). During the sub-slot 340(1) of slot 338(2) of the CG period 339, the UE 115 may transmit to the receiving UE 115(c) via the common sub-PSSCH of the slot 338(2). In this manner, the UE 115 may choose, for each slot 338, between transmitting to receiving UE 115(b) or receiving UE 115(c) via the common sub-PSSCH in the sub-slot 340(1). This method may facilitate the UE 115 transmitting to receiving UE 115(b) or receiving UE 115(c) in different time periods using the same sub-PSSCH index.

A UE 115 may transmit to receiving UE 115(b) or receiving UE 115(c) in the same sub-PSSCH (e.g., using the same sub-PSSCH index) based on the CG configuring the resources. For example, the receiving UE 115(b) or receiving UE 115(c) may receive a CG indicating parameters including a receiving UE identifier indicating which of the receiving UE 115(b) or receiving UE 115(c) that the CG is intended for, the MCS, the TBS, a sub-PSSCH pattern, and/or a DMRS configuration (e.g., resource location of the DMRS). The UE 115 may transmit a TB in the same sub-PSSCH to receiving UE 115(b) or receiving UE 115(c) with an identifier that identifies the intended receiving UE. For example, the UE 115 may transmit a TB in the same sub-PSSCH with a layer 2 (e.g., MAC layer) identifier identifying the intended receiving UE 115(b) or 115(c). Referring to the example above, both the receiving UE 115(b) and receiving UE 115(c) may decode the TB in the same sub-PSSCH in the same sub-slot 340(1) in the same slot 338 and determine whether the TB was intended for itself or another UE based on the layer 2 UE identifier. The receiving UE 115(b) and receiving UE 115(c) may compare the layer 2 UE identifier in the TB to its own layer 2 UE identifier to determine whether it is the intended receiver of the TB.

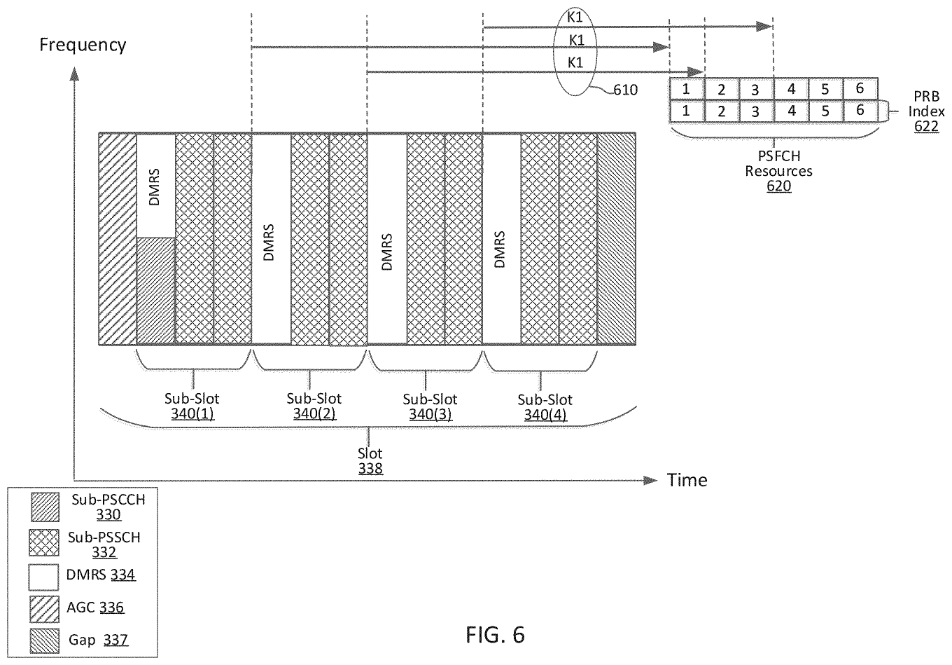

FIG. 6 illustrates PSFCH resources 620 mapped to sub-slots 340 according to some aspects of the present disclosure. In FIG. 6, the x-axis represents time in some arbitrary units and the Y-axis represents frequency in some arbitrary units. In FIG. 6, slot 338 is shown partitioned into sub-slots 340 based on a CG. The UE (e.g., the UE 115, the UE 800) may map sub-slots 340(1) . . . 340(4) in the slot 338 based on the CG. In some instances, the CG may allow the UE 115 to transmit TBs to other UEs 115 without requiring the UE 115 to request resources from the BS 105 on a dynamic basis. Accordingly, the UE 115 may perform sidelink communications with other UEs 115 based on the CG received from the BS 105.

In some aspects, the transmitting UE 115 may receive, from the receiving UE 115, an indicator indicating whether the TB was successfully received (e.g., successfully decoded). In this regard, the transmitting UE 115 may receive a HARQ ACK/NACK via a physical sidelink feedback channel (PFSCH). If the receiving UE 115 decodes the TB successfully, the receiving UE 115 may transmit a HARQ acknowledgement (ACK) to the transmitting UE 115. Conversely, if the receiving UE 115 fails to decode the TB successfully, the receiving UE 115 may transmit a HARQ negative-acknowledgement (NACK) to the transmitting UE 115. In some instances, upon receiving a HARQ NACK from the receiving UE 115, the transmitting UE 115 may retransmit the TB to the receiving UE 115. In some aspects, the CG may configure the time/frequency resources for the PFSCH resources 620. In some instances, the UE 115 may receive the indicator in PFSCH resources 620 based on a resource index (e.g., a time domain resource index, a frequency domain resource index, and/or a PRB index 622) associated with the sub-slot 340 in which the TB was transmitted. In this regard, the time/frequency resources for the PFSCH associated with a sub-slot 340 carrying the TB may be based on, without limitation, a layer 1 identifier of the transmitting UE 115, a unicast/groupcast identifier, and/or a hashing function of an index associated with the sub-slot 340. In some aspects, the hashing function may include a message digest hash algorithm (e.g., MD4, MD5) and/or a secure hash algorithm (e.g., SHA-1, SHA-2).

In some aspects, the transmitting UE 115 may receive the indicator indicating whether the TB was successfully received by the receiving UE 115 in PSFCH resources 620 based on an offset 610 from resources associated with the sub-slot 340. In some aspects, the CG may indicate to a receiving UE 115 the PSFCH resources 620 associated with a sub-PSSCH in the sub-slot 340. The transmitting UE 115 may transmit the CG to the receiving UE 115. Additionally or alternatively, the BS 105 may transmit the CG to the receiving UE 115. The CG may indicate one or more PSFCH resources 620 for transmission of HARQ feedback (e.g., ACK/NACK feedback) associated with a corresponding sub-PSSCH in the sub-slot 340. For example, the CG may indicate the offset 610 between the sub-slot 340 (e.g., a starting symbol of the sub-slot 340 or an ending symbol of the sub-slot 340) and a corresponding PSFCH resource 620 (e.g., a time and/or frequency domain resource) in which HARQ feedback, corresponding to the sub-slot 340, is to be transmitted. In this regard, the offset 610 may be indicated as a number of symbols to enable greater scheduling flexibility and reduced latency as compared to signaling a slot 338 for the HARQ feedback.

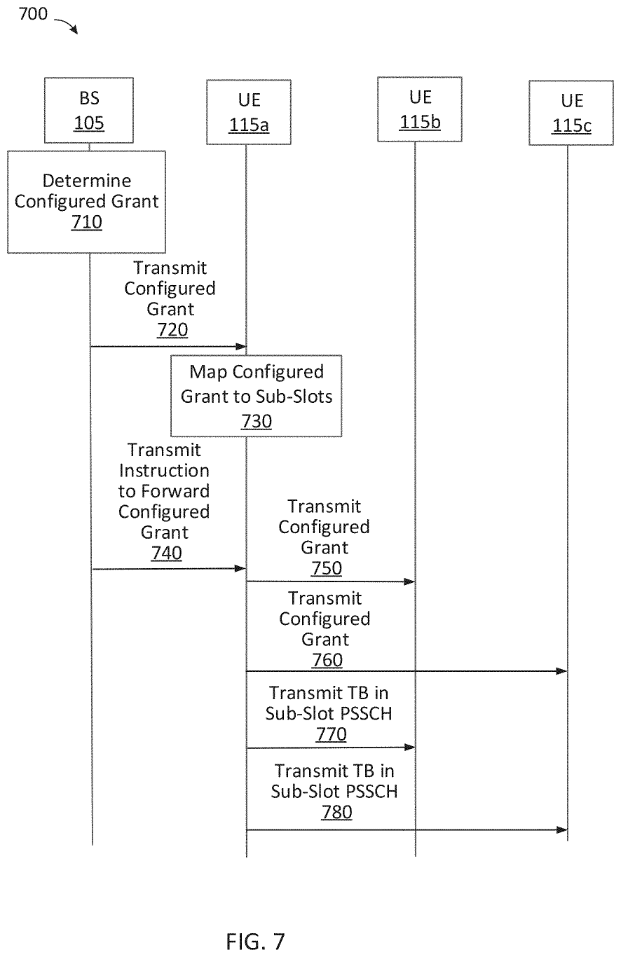

FIG. 7 is a signaling diagram of a communication method according to some aspects of the present disclosure. Steps of the signaling diagram 700 can be executed by a computing device (e.g., a processor, processing circuit, and/or other suitable component) of a communication device or other suitable means for performing the steps. For example, a communication device, such as the BS 105 or the BS 900, may utilize one or more components, such as a processor 902, a memory 904, instructions 906, a configured grant module 908, a transceiver 910, a modem 912, an RF unit 914, and one or more antennas 916 to execute the steps of method signaling diagram 700. A wireless communication device, such as the UE 115 or UE 800, may utilize one or more components, such as the processor 802, the memory 804, the configured grant module 808, the transceiver 810, the modem 812, and the one or more antennas 816, to execute signaling diagram 700.

At 710, a BS 105 may determine a configured grant. The BS 105 may operate in sidelink mode 1 and communicate the CG to the UE 115a. The CG may include time and frequency resources associated with a plurality of sub-slots of a slot. The CG may include a modulation and coding scheme (MCS) associated with the plurality of sub-slots. The MCS may include the modulation format and/or coding rate applied to the sub-PSSCHs associated with the sub-slots. The MCS may be used by one or more receiving UEs 115b or 115c to decode transmissions received from a transmitting UE 115a. The CG may include one or more UE identifiers to indicate the UE(s) associated with the CG. The CG may include the transport block size (TBS). The transport block size may be based on the modulation order, the code rate, and/or the number of physical resource blocks (PRBs) used. The CG may include a sub-slot pattern that indicates which sub-slots may be used by the UE 115a to periodically transmit to UEs 115b or 115c.

At 720, the BS 105 may transmit the CG to UE 115a. In this regard, the BS 105 may transmit the CG in an RRC configuration message, a DCI message, and/or a MAC control element signaling via a physical downlink shared channel (PDSCH), a physical downlink control channel (PDCCH), or other suitable channel to the UE 115a.

At 730, the UE 115a may map the CG to sub-slots of a slot. In some aspects, the UE 115a may map the CG to a series of sub-slots in a CG period as described above with reference to FIGS. 4 and 5. The UE 115a may map a sub-PSCCH, a sub-PSSCH, an SCI-1, an AGC symbol, and a gap symbol to any or all of the sub-slots in the slot.

At 740, the BS 105 may transmit an instruction to the UE 115a to forward the CG to the UE 115b and UE115c. In this regard, the BS 105 may transmit the instruction to the UE 115a in an RRC message and/or a DCI message (e.g., a unicast DCI3 message and/or a groupcast DCI3 message).

At 750, the UE 115a may transmit the CG to the UE 115b in response to receiving the instruction. At 760, the UE 115a may transmit the CG to the UE 115c in response to receiving the instruction. In some aspects, each UE in the network may receive the CG from the BS 105. In some aspects, the UE 115a may receive the CG from the BS 105 and transmit (e.g., forward) the CG to other UEs. For example, when the UEs 115b and 115c are out of range of the BS 105, the UE 115a may forward the CG to the UEs 115b and 115c. In this regard, the UE 115a may transmit the CG to the UEs 115b and 115c via a PSCCH, a sub-PSCCH, a PSSCH and/or a sub-PSSCH.

In some aspects, the UE 115a may transmit, to the UEs 115b and 115c, an instruction that instructs the UEs 115b and 115c to enable (e.g., activate) a semi-persistent scheduling (SPS) resource allocation mode. The SPS based resource allocation mode may include a mode in which the UEs 115b and 115c are allocated resources included in the CG semi-statically over a certain time interval or time period. In this regard, the time interval or time period may include a CG period. In some aspects, the BS 105 may transmit an instruction to the UEs 115b and 115c to enable the SPS resource allocation mode when the UEs 115b and 115c are in coverage range of the BS 105. In this regard, the BS 105 may transmit an instruction to the UEs 115b and 115c to enable the SPS resource allocation mode via a physical downlink control channel (PDCCH). When the UEs 115b and 115c are out of coverage range of the BS 105, the UE 115a may transmit an instruction to the UEs 115b and 115c to enable the SPS resource allocation mode via SCI (e.g., first stage SCI-1) or other signaling. The UE 115a may receive an indicator from the BS 105 indicating that the UEs 115b and 115c are out of the coverage range of the BS 105. The UE 115a may transmit the instruction to the UEs 115b and 115c to enable the SPS resource allocation mode based on an out of coverage range indicator from the BS 105.

The SPS based resource allocation received by the UEs 115b and 115c may be configured consistent with the CG received by the UE 115a. In this regard, the communication parameters in the SPS based resource allocation may be configured to match one or more of the CG parameters to facilitate successful transmissions from the UE 115a to the UEs 115b and 115c. For example, the matching parameters may include, without limitation, a CG period, time/frequency resource allocations for the sub-slots, a sub-slot pattern, a HARQ ID resource pool, a HARQ ID resource determination process, a MCS, a TBS, and/or a DMRS configuration. In some aspects, the parameters determined by the BS 105 for the CG may change over time. For example, the time/frequency resources for sidelink communication between the UEs may change in each CG period. The UE 115a may receive an updated CG that includes the parameter changes and/or the SPS based resource allocation parameters may be updated accordingly.

At 770, the UE 115a may transmit a TB to the UE 115b in a sub-PSSCH associated with a sub-slot of a slot. In some aspects, the UE 115a may transmit padding in at least one sub-slot of the slot. For example, the UE 115a may transmit a TB that includes padding in at least one sub-slot. In some aspects, the padding may be transmitted in the last sub-slot(s) of the slot.

At 780, the UE 115a may transmit a TB to the UE 115c in a sub-PSSCH associated with a sub-slot of a slot. In some aspects, the UE 115a may transmit the TB with a layer 2 UE identifier that indicates which UE the TB is intended for.

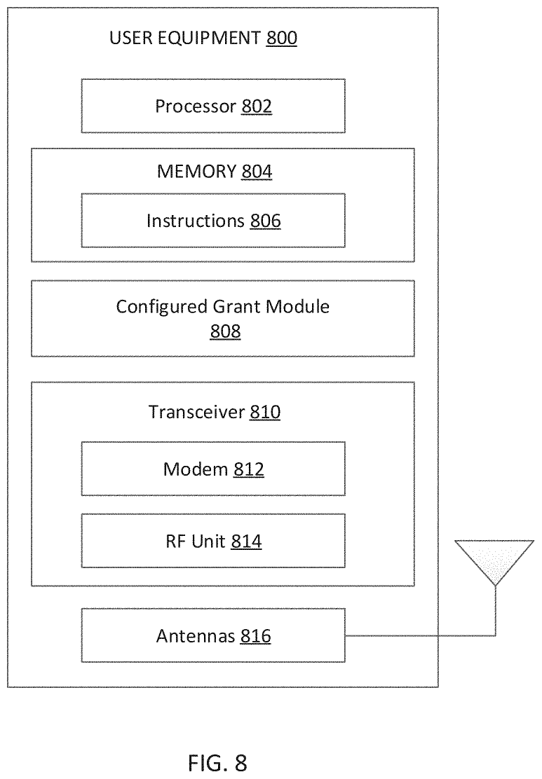

FIG. 8 is a block diagram of an exemplary UE 800 according to some aspects of the present disclosure. The UE 800 may be the UE 115 in the network 100 or 200 as discussed above. As shown, the UE 800 may include a processor 802, a memory 804, a configured grant module 808, a transceiver 810 including a modem subsystem 812 and a radio frequency (RF) unit 814, and one or more antennas 816. These elements may be coupled with each other and in direct or indirect communication with each other, for example via one or more buses.

The processor 802 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 802 may also be implemented as a combination of computing devices, e.g., a combination of a DSP and a microprocessor, a plurality of microprocessors, one or more microprocessors in conjunction with a DSP core, or any other such configuration.

The memory 804 may include a cache memory (e.g., a cache memory of the processor 802), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In some instances, the memory 804 includes a non-transitory computer-readable medium. The memory 804 may store instructions 806. The instructions 806 may include instructions that, when executed by the processor 802, cause the processor 802 to perform the operations described herein with reference to the UEs 115 in connection with aspects of the present disclosure, for example, aspects of FIGS. 2-7 and 10-11. Instructions 806 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

The configured grant module 808 may be implemented via hardware, software, or combinations thereof. For example, the configured grant module 808 may be implemented as a processor, circuit, and/or instructions 806 stored in the memory 804 and executed by the processor 802.

The configured grant module 808 may be used for various aspects of the present disclosure, for example, aspects of FIGS. 2-7 and 10-11. The configured grant module 808 is configured to enable the UE 800 to communicate transport blocks (TBs) to multiple UEs via sub-slots in a slot. The configured grant module 808 enables partitioning of the sub-slots and configuring the resources for transmissions based on the CG. In some aspects of the present disclosure, the latency of wireless communications, including sidelink control and data communications, may be reduced by configuring the resources for a UE to transmit multiple TBs in sub-slots in a slot using a configured grant module 808 as compared to configuring the resources using second stage sidelink control information (SCI-2).

As shown, the transceiver 810 may include the modem subsystem 812 and the RF unit 814. The transceiver 810 can be configured to communicate bi-directionally with other devices, such as the BSs 105 and/or the UEs 115. The modem subsystem 812 may be configured to modulate and/or encode the data from the memory 804 and the configured grant module 808 according to a modulation and coding scheme (MCS), e.g., a low-density parity check (LDPC) coding scheme, a turbo coding scheme, a convolutional coding scheme, a digital beamforming scheme, etc. The RF unit 814 may be configured to process (e.g., perform analog to digital conversion or digital to analog conversion, etc.) modulated/encoded data from the modem subsystem 812 (on outbound transmissions) or of transmissions originating from another source such as a UE 115 or a BS 105. The RF unit 814 may be further configured to perform analog beamforming in conjunction with the digital beamforming. Although shown as integrated together in transceiver 810, the modem subsystem 812 and the RF unit 814 may be separate devices that are coupled together to enable the UE 800 to communicate with other devices.

The RF unit 814 may provide the modulated and/or processed data, e.g. data packets (or, more generally, data messages that may contain one or more data packets and other information), to the antennas 816 for transmission to one or more other devices. The antennas 816 may further receive data messages transmitted from other devices. The antennas 816 may provide the received data messages for processing and/or demodulation at the transceiver 810. The antennas 816 may include multiple antennas of similar or different designs in order to sustain multiple transmission links. The RF unit 814 may configure the antennas 816.

In some instances, the UE 800 can include multiple transceivers 810 implementing different RATs (e.g., NR and LTE). In some instances, the UE 800 can include a single transceiver 810 implementing multiple RATs (e.g., NR and LTE). In some instances, the transceiver 810 can include various components, where different combinations of components can implement RATs.

In some aspects, the processor 802 may be coupled to the memory 804, the configured grant module 808, and/or the transceiver 810. The processor 802 and may execute operating system (OS) code stored in the memory 804 in order to control and/or coordinate operations of the configured grant module 808 and/or the transceiver 810. In some aspects, the processor 802 may be implemented as part of the configured grant module 808.

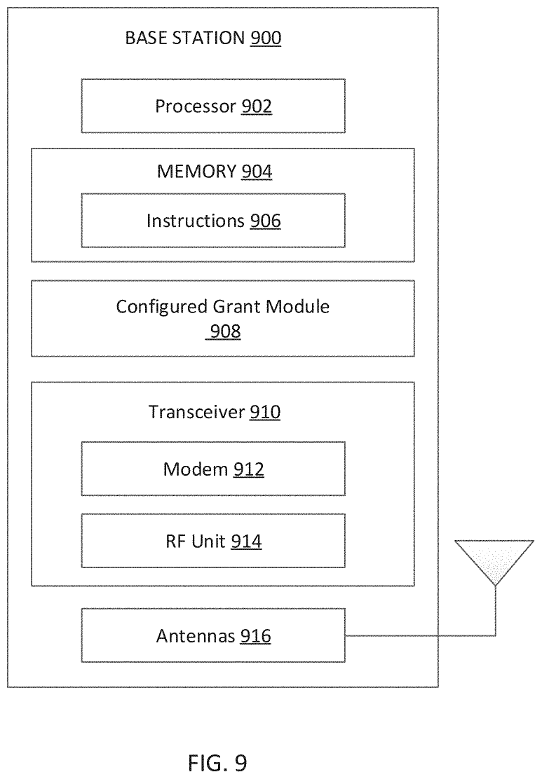

FIG. 9 is a block diagram of an exemplary BS 900 according to some aspects of the present disclosure. The BS 900 may be a BS 105 as discussed above. As shown, the BS 900 may include a processor 902, a memory 904, a configured grant module 908, a transceiver 910 including a modem subsystem 912 and a RF unit 914, and one or more antennas 916. These elements may be coupled with each other and in direct or indirect communication with each other, for example via one or more buses.

The processor 902 may have various features as a specific-type processor. For example, these may include a CPU, a DSP, an ASIC, a controller, a FPGA device, another hardware device, a firmware device, or any combination thereof configured to perform the operations described herein. The processor 902 may also be implemented as a combination of computing devices, e.g., a combination of a DSP and a microprocessor, a plurality of microprocessors, one or more microprocessors in conjunction with a DSP core, or any other such configuration.

The memory 904 may include a cache memory (e.g., a cache memory of the processor 902), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some instances, the memory 904 may include a non-transitory computer-readable medium. The memory 904 may store instructions 906. The instructions 906 may include instructions that, when executed by the processor 902, cause the processor 902 to perform operations described herein, for example, aspects of FIGS. 2-7 and 10-11. Instructions 906 may also be referred to as code, which may be interpreted broadly to include any type of computer-readable statement(s).

The configured grant module 908 may be implemented via hardware, software, or combinations thereof. For example, the configured grant module 908 may be implemented as a processor, circuit, and/or instructions 906 stored in the memory 904 and executed by the processor 902.

The configured grant module 908 may be used for various aspects of the present disclosure, for example, aspects of FIGS. 2-6 and 9-10. The configured grant module 908 is configured to transmit, to a UE (e.g., the UE 115, the UE 800), a configuration indicating LBT parameters that defines the parameters for the UE 115 or UE 800 to access the channel. For example, the BS 900 may configure the time resources and/or frequency resources associated with the sub-slots including a sub-slot RP and/or a slot RP. The configuration may further include a starting subchannel index associated with the sub-slot and a number of subchannels associated with the sub-slot. The configuration may include a modulation and coding scheme for decoding a second-stage SCI-2 and/or the sub-PSSCH of the sub-slot. The configuration may include a search space period associated with the plurality of sub-slots.

Additionally or alternatively, the configured grant module 908 can be implemented in any combination of hardware and software, and may, in some implementations, involve, for example, processor 902, memory 904, instructions 906, transceiver 910, and/or modem 912.

As shown, the transceiver 910 may include the modem subsystem 912 and the RF unit 914. The transceiver 910 can be configured to communicate bi-directionally with other devices, such as the UEs 115 and/or 800. The modem subsystem 912 may be configured to modulate and/or encode data according to a MCS, e.g., a LDPC coding scheme, a turbo coding scheme, a convolutional coding scheme, a digital beamforming scheme, etc. The RF unit 914 may be configured to process (e.g., perform analog to digital conversion or digital to analog conversion, etc.) modulated/encoded data from the modem subsystem 912 (on outbound transmissions) or of transmissions originating from another source such as a UE 115 or UE 800. The RF unit 914 may be further configured to perform analog beamforming in conjunction with the digital beamforming. Although shown as integrated together in transceiver 910, the modem subsystem 912 and/or the RF unit 914 may be separate devices that are coupled together at the BS 900 to enable the BS 900 to communicate with other devices.

The RF unit 914 may provide the modulated and/or processed data, e.g. data packets (or, more generally, data messages that may contain one or more data packets and other information), to the antennas 916 for transmission to one or more other devices. This may include, for example, a configuration indicating a plurality of sub-slots within a slot according to aspects of the present disclosure. The antennas 916 may further receive data messages transmitted from other devices and provide the received data messages for processing and/or demodulation at the transceiver 910. The antennas 916 may include multiple antennas of similar or different designs in order to sustain multiple transmission links.

In some instances, the BS 900 can include multiple transceivers 910 implementing different RATs (e.g., NR and LTE). In some instances, the BS 900 can include a single transceiver 910 implementing multiple RATs (e.g., NR and LTE). In some instances, the transceiver 910 can include various components, where different combinations of components can implement RATs.

In some aspects, the processor 902 may be coupled to the memory 904, the configured grant module 908, and/or the transceiver 910. The processor 902 may execute OS code stored in the memory 904 to control and/or coordinate operations of the configured grant module 908, and/or the transceiver 910. In some aspects, the processor 902 may be implemented as part of the configured grant module 908. In some aspects, the processor 902 is configured to transmit via the transceiver 910, to a UE, an indicator indicating a configuration of sub-slots within a slot.

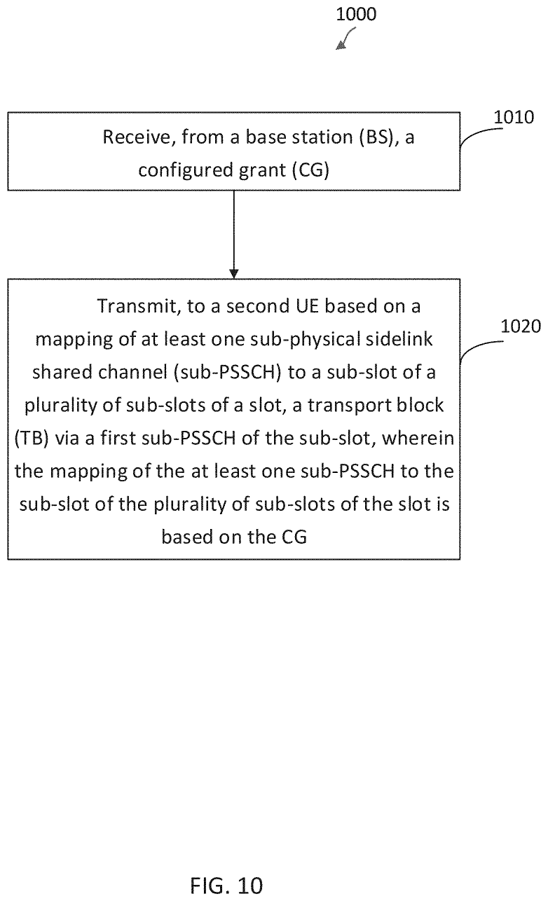

FIG. 10 is a flow diagram of a communication method 1000 according to some aspects of the present disclosure. Aspects of the method 1000 can be executed by a computing device (e.g., a processor, processing circuit, and/or other suitable component) of a wireless communication device or other suitable means for performing the steps. For example, a wireless communication device, such as the UE 115 or UE 800, may utilize one or more components, such as the processor 802, the memory 804, the configured grant module 808, the transceiver 810, the modem 812, and the one or more antennas 816, to execute aspects of method 1000. The method 1000 may employ similar mechanisms as in the networks 100 and 200 and the aspects and actions described with respect to FIGS. 2-7. As illustrated, the method 1000 includes a number of enumerated steps, but the method 1000 may include additional steps before, after, and in between the enumerated steps. In some aspects, one or more of the enumerated steps may be omitted or performed in a different order.

At 1010, the method 1000 includes a UE (e.g., the UE 115 or the UE 800) receiving, from a base station (BS) (e.g., the BS 105 or the BS 900), a configured grant (CG). In this regard, the UE may receive the CG from the BS using RRC signaling. In some instances, the CG may allow the UE to transmit transport blocks (TBs) to other UEs without requiring the UE to request resources from the BS on a dynamic basis. Accordingly, the UE may perform sidelink communications with other UEs based on the CG received from the BS.

The CG may provide the UE with resources to use in transmitting a TB and/or one or more retransmissions (e.g., 1, 2, or other number of retransmissions). Nearby UEs operating in sidelink mode 2 may know which resources UEs in sidelink mode 1 will utilize. One or more nearby UEs may receive the CG that informs the UE as to which resources are used by other UEs. The one or more nearby UEs may receive the CG from another UE and/or receive the CG from a BS. Each UE may decode the CG to determine where the reserved resources are located (e.g., in order to refrain from using resources that are reserved for another sidelink transmission and/or to reduce resource collision within the wireless communications network). The BS may allocate the CG resources to multiple UEs, each UE of the multiple UEs may utilize the resources of the CG when they have data to transmit to another UE and/or to a BS. In some aspects, the BS may allocate a pool of resources that may be shared among the UEs. The UEs may select resources from the shared pool of resources when they have data to transmit to another UE and/or to a BS. In some aspects, the BS may dedicate (e.g., reserve) resources to each of the UEs. The dedicated resources may be used exclusively by the UEs. Each UE may select resources from the dedicated resources assigned to the respective UE when they have data to transmit to another UE and/or to a BS. By assigning the CG resources, the wireless network eliminates the packet transmission delay for a scheduling request procedure and increases the utilization ratio of allocated periodic radio resources. The CG may reduce the delay caused by the dynamic scheduling request procedure by pre-allocating sidelink radio resources for use by UEs for sidelink communications. For example, the UE may receive a CG with one or more slot resources (e.g., one, two, three, or other number of slot resources) in a CG period. In some instances, the BS assigns a set of sidelink resources to a UE for each sub-slot of each slot up to the slot limit of the CG. In some aspects, the CG may be limited to a number of slots. For example, the CG may be limited to 1, 2, 3, or more slots. In some aspects, the UE may transmit a message to the BS indicating information about the expected data traffic, including one or more of a periodicity of TBs, a TB maximum size, and/or QoS information. In some instances, the QoS information may include the latency budget and/or reliability required by the TBs and/or the priority of the TBs. This information may be used by the BS to create, configure, and/or allocate the CG to the UE in a manner that satisfies the requirements of the data traffic of the UE. The CG may be configured using a set of parameters that includes the CG index, the time-frequency resource allocation for the sub-slots, and/or the periodicity of the allocated resources.

In some instances, the CG allows for periodic transmissions by the UE without a dynamic grant. Sidelink mode 1 defines two types of CG schemes: CG type 1 and CG type 2. In both CG type 1 and CG type 2, the CG may be configured using RRC signaling. CG type 1 may be utilized by the UE immediately after receiving the CG until it is released by the BS. In CG type 1, the CG may be activated/deactivated by the BS using RRC signaling. The UE may use a CG type 2 only after it is activated by the BS and until it is deactivated by the BS. In this regard, the UE may receive, from the BS an activation/deactivation message via DCI signaling. With CG type 2, a BS may configure multiple CGs for a UE and only activate a subset of the CGs based on the UE needs. Resources in non-active CGs of a UE may be allocated to other UEs.

In some aspects, the CG may configure and/or include parameters that may be carried by a second-stage sidelink control information (SCI-2). For example, the CG may include time and frequency resources associated with a plurality of sub-slots of a slot. The CG may include a modulation and coding scheme (MCS) associated with the plurality of sub-slots. The MCS may include the modulation format and/or coding rate applied to the sub-PSSCHs associated with the sub-slots. The MCS may be used by one or more receiving UEs to decode transmissions received from a transmitting UE. The CG may include one or more UE identifiers to indicate the UE(s) associated with the CG. The CG may include the transport block size (TBS). The transport block size may be based on the modulation order, the code rate, and/or the number of physical resource blocks (PRBs) used. The CG may include a sub-slot pattern that indicates which sub-slots may be used to periodically transmit to a particular receiving UE. For example, the sub-slot pattern may indicate one or more sub-slots (e.g., 1, 2, 3, 4, etc., including all of the sub-slots) in the slot are assigned to a particular receiving UE. In some instances, the sub-slot pattern may indicate every second sub-slot in the slot is assigned to a particular UE. In some instances, the sub-slot pattern may indicate every third sub-slot in the slot is assigned to a particular UE. Any suitable sub-slot pattern may be utilized.

The CG may include a configuration for the demodulation reference signal (DMRS) associated with the plurality of sub-slots. The DMRS may be a reference signal used by a receiving UE for channel estimation and/or compensating for Doppler effects. The DMRS may be included in at least one sub-slot of the plurality of sub-slots of the slot. In this regard, the DMRS may be located anywhere within the sub-slot. For example, the DMRS may be located in the first symbol of the sub-slot, the last symbol of the sub-slot, or an intermediate symbol of the sub-slot. In some aspects, the DMRS may include all resource elements (REs) within the symbol. In some aspects, the DMRS may include a portion of the REs, but less than all of the REs within the symbol. The transmitting UE may transmit the DMRS based on the CG. The CG may include a DMRS configuration. The DMRS configuration may include the number of DMRSs in a slot and the time/frequency resources associated with the DMRS. The receiving UE may monitor for the demodulation reference signal (DMRS) to estimate the channel in the time/frequency resources indicated in the CG.

In some aspects, the UE may receive, from the BS, a plurality of CGs associated with a plurality of sub-slots. In this regard, the UE may receive the plurality of CGs from the BS using RRC signaling. Each of the CGs of the plurality of CGs may be identified by a CG identifier. For example, the CG identifier may include a CG index. In some aspects, each sub-slot of the plurality of sub-slots may be assigned a CG. For example, if a slot includes four sub-slots, each of the four sub-slots may have an associated CG. In some instances, a CG may cover multiple sub-slots of the plurality of sub-slots. Each of the CGs may be distinguished from one another by an index associated with the individual CG. The CG index may be a value corresponding to a sub-slot index, a slot number, a sequence frame number, and/or a combination thereof.

In some aspects, the UE may receive a message from the BS indicating which CG(s) of the plurality of CGs the UE may use. In this regard, the UE may receive the message from the BS indicating the CG(s) available for use by the UE via an RRC message and/or a downlink control information (DCI) message (e.g., a unicast DCI3 message and/or a groupcast DCI3 message).

In some aspects, the CG may include at least one physical sidelink feedback channel (PSFCH) resource mapped to each sub-slot of the plurality of sub-slots. A PSFCH may carry feedback (e.g., hybrid automatic repeat request (HARQ)) related to the successful or failed reception of a sidelink transmission. For example, the feedback may include an acknowledgment (e.g., ACK) or negative acknowledgement (e.g., NACK) that indicates whether the TB was successfully decoded by the receiving UE.

The PSFCH resources may be allocated periodically. A UE may transmit an ACK/NACK or other communication on the PSFCH in response to receiving a sub-PSSCH in a previous sub-slot. The PSFCH can carry the HARQ feedback from the receiving UE to the transmitting UE. Within the CG, resources for PSFCH may be configured periodically with a period corresponding to a number of sub-slots and/or a number of slots (e.g., 1, 2, 4, or other number of sub-slots and/or slots). In some instances, the PSFCH may be located in one symbol among the last symbols in a slot and/or among the last symbols of a sub-slots. In some aspects, the PSFCH may be located in the symbol prior to a guard symbol of a slot and/or a sub-slot.

At 1020, the method 1000 includes the UE transmitting a TB to another UE via a sub-PSSCH of the sub-slot based on a mapping of the sub-PSSCH to the sub-slot of a plurality of sub-slots of the slot. The mapping of the sub-PSSCH to the sub-slot of the plurality of sub-slots of the slot may be based on the CG. In some aspects, the UE may transmit a TB in each sub-slot of the plurality of sub-slots within the slot. The UE may transmit a TB in each sub-slot to one other UE and/or to multiple different UEs. Accordingly, the UE may transmit multiple TBs to a single UE and/or transmit different TBs to different UEs via the plurality of sub-slots within the slot.

In some aspects, the UE may transmit padding in at least one sub-slot of the plurality of sub-slots. For example, the UE may transmit a TB that includes padding in at least one sub-slot. The padding may include random data. The padding may be transmitted by the UE without a particular UE destination ID. In some aspects, the padding may be transmitted in the last sub-slot of the plurality of sub-slots of a slot. For example, in some instances, the UE may transmit a TB in a leading sub-slot and transmit padding in one or more subsequent sub-slots up to a border between the last sub-slot of the slot and a subsequent slot. In some aspects, the network (e.g., the network 100 or 200) may include a mix of both UEs that support the sub-slot structure and legacy UEs that do not support the sub-slot structure, but support the slot structure. In this case of mixed UEs, a sub-slot-based UE may transmit padding in at least one sub-slot to reduce interference effects on legacy slot-based UEs that receive TBs based on the slot structure. This may facilitate the legacy UEs to maintain proper gain setting of a receiver of the legacy UEs.

In some aspects, the UE may transmit the TB in a sub-PSSCH associated with a sub-slot of the plurality of sub-slots. The CG may include information for mapping the sub-PSSCH to one or more sub-slots of the plurality of sub-slots. In some aspects, the UE may refrain from transmitting a second stage sidelink control information (SCI-2) during the sub-slot mapped with a sub-PSSCH. The SCI-2 may include information such as the MCS for the sub-PSSCH, the TBS, sub-slot pattern for the plurality of sub-slots, the DMRS configuration, and/or the HARQ process ID. Aspects of the present disclosure may eliminate the need for the SCI-2 by including the information carried by the SCI-2 in the CG. By receiving the information via the CG and eliminating the SCI-2, the UEs may reduce computing resources and/or power consumption as compared to receiving the information via the SCI-2. For example, the UE may reduce power consumption by not performing blind decoding on the SCI-2. In some aspects, the UE may receive the CG from the BS and transmit the CG to another UE. For example, when the other UE is out of range of the BS, the UE may forward the CG to the other UE.

In some aspects, the UE may transmit a first TB to a first receiving UE in a first subset of sub-slots of the plurality of sub-slots of the slot. The UE may also transmit a second TB to a second receiving UE in a second subset of sub-slots of the plurality of sub-slots of the slot. The second subset of sub-slots may be different from the first subset of sub-slots. The UE may transmit different TBs to different UEs within the different subsets of sub-slots. In some aspects, the UE may transmit different TBs to different UEs within the subsets of sub-slots on a periodic basis. In this regard, the periodic basis may be based on a pattern associated with the sub-slots. The CG may include the sub-slot pattern to facilitate the periodic transmission. For example, in some instances a slot may include 4 sub-slots and the UE may transmit TBs to the first receiving UE in a sub-slot pattern that includes the first and third sub-slots and transmit TBs to the second receiving UE in a sub-slot pattern that includes the second and fourth sub-slots. The UE may periodically repeat the transmissions using the sub-slot pattern for each slot of the CG period. The CG period may include 2, 3, 4, or more slots. As another example, a slot may include 4 sub-slots and the UE may transmit TBs to the first receiving UE in sub-slot pattern that includes the first and second sub-slots and transmit other TBs to the second receiving UE in a sub-slot pattern that includes the third and fourth sub-slots. The UE may transmit any number of TBs to any number of UEs using a repeating sub-slot pattern.

In some aspects, the CG may assign a sub-PSSCH associated with a sub-slot to multiple receiving UEs. In this regard, the CG may assign the same sub-PSSCH to multiple UEs. For example, the CG may assign the same sub-PSSCH (e.g., the same set of symbols belonging to the sub-PSSCH in a sub-slot) to a first receiving UE and a second receiving UE. The CG may assign this same sub-PSSCH to a transmitting UE for transmitting to multiple receiving UEs. The transmitting UE may transmit to either the first receiving UE or the second receiving UE via the same sub-PSSCH in the sub-slot. For example, during a first sub-slot of a first slot of a CG period, the UE may transmit to the first receiving UE via the common sub-PSSCH of the first slot. During the first sub-slot of a second slot (e.g., a slot following the first slot in time) of the CG period, the UE may transmit to the second receiving UE via the common sub-PSSCH of the second slot. In this manner, the UE may choose, for each slot, between transmitting to the first or second receiving UE via the common PSSCH in a sub-slot. This method may facilitate the UE transmitting to different UEs in different time periods using the same PSSCH index.

A UE may transmit to other receiving UEs in the same sub-PSSCH (e.g., using the same sub-PSSCH index) based on the CG configuring the resources. For example, the receiving UEs may receive a CG indicating parameters including a receiving UE identifier indicating the UE(s) that the CG is intended for, the MCS, the TBS, a sub-PSSCH pattern, and/or a DMRS configuration (e.g., resource location of the DMRS). The UE may transmit a TB in the same sub-PSSCH to different UEs with an identifier that identifies the intended receiving UE. For example, the UE may transmit a TB in the same sub-PSSCH with a layer 2 (e.g., MAC layer) identifier identifying the intended receiving UE. Referring to the example above, both the first receiving UE and the second receiving UE may decode the TB in the same sub-PSSCH in the same sub-slot and determine whether the TB was intended for itself or another UE based on the layer 2 UE identifier. The first receiving UE and the second receiving UE may compare the layer 2 UE identifier in the TB to its own layer 2 UE identifier to determine whether it is the intended receiver of the TB.

In some aspects, the UE may receive, from a BS (e.g., the BS 105 or the BS 900), an instruction that instructs the UE to transmit a CG to another UE. The UE may transmit the CG to the other UE in response to receiving the instruction. In this regard, the UE may receive the instruction in an RRC message and/or a DCI message (e.g., a unicast DCI3 message and/or a groupcast DCI3 message) from the BS. In some aspects, each UE in the network may receive the CG from the BS. In some aspects, the UE may receive the CG from the BS and transmit (e.g., forward) the CG to another UE. For example, when the other UE is out of range of the BS, the UE may forward the CG to the other UE. In this regard, the UE may transmit the CG to the other UE via a PSCCH, a sub-PSCCH, a PSSCH and/or a sub-PSSCH.

In some aspects, the UE may transmit, to a receiving UE, an instruction that instructs the receiving UE to enable (e.g., activate) a semi-persistent scheduling (SPS) resource allocation mode. The SPS based resource allocation mode may include a mode in which the receiving UE is allocated resources included in the CG semi-statically over a certain time interval or time period. In this regard, the time interval or time period may include a CG period. In some aspects, a BS may transmit an instruction to the receiving UE to enable the SPS resource allocation mode when the receiving UE is in coverage range of the BS. In this regard, the BS may transmit an instruction to the receiving UE to enable the SPS resource allocation mode via a physical downlink control channel (PDCCH). When the receiving UE is out of coverage range of the BS, a transmitting UE may transmit an instruction to the receiving UE to enable the SPS resource allocation mode via SCI (e.g., first stage SCI-1) or other signaling. The transmitting UE may receive an indicator from the BS indicating that the receiving UE is out of the coverage range of the BS. The transmitting UE may transmit the instruction to the receiving UE to enable the SPS resource allocation mode based on the out of coverage range indicator from the BS.

The SPS based resource allocation received by the receiving UE may be configured consistent with the CG received by the transmitting UE. In this regard, the communication parameters in the SPS based resource allocation may be configured to match one or more of the CG parameters to facilitate successful transmissions from the transmitting UE to the receiving UE. For example, the matching parameters may include, without limitation, a CG period, time/frequency resource allocations for the sub-slots, a sub-slot pattern, a HARQ ID resource pool, a HARQ ID resource determination process, a MCS, a TBS, and/or a DMRS configuration. In some aspects, the parameters determined by the BS for the CG may change over time. For example, the time/frequency resources for sidelink communication between the UEs may change. The transmitting UE may receive an updated CG that includes the parameter changes and/or the SPS based resource allocation parameters may be updated accordingly.

In some aspects, the transmitting UE may receive, from the receiving UE, an indicator indicating whether the TB was successfully received (e.g., successfully decoded). In this regard, the transmitting UE may receive a HARQ ACK/NACK via a physical sidelink feedback channel (PFSCH). If the receiving UE decodes the TB successfully, the receiving UE may transmit a HARQ acknowledgement (ACK) to the transmitting UE. Conversely, if the receiving UE fails to decode the TB successfully, the receiving UE may transmit a HARQ negative-acknowledgement (NACK) to the transmitting UE. In some instances, upon receiving a HARQ NACK from the receiving UE, the transmitting UE may retransmit the TB to the receiving UE. In some aspects, the CG may configure the time/frequency resources for the PFSCH. In some instances, the UE may receive the indicator in PFSCH resources based on a resource index (e.g., a time domain resource index, a frequency domain resource index, and/or a PRB index) associated with the sub-slot in which the TB was transmitted. In this regard, the time/frequency resources for the PFSCH associated with a sub-slot carrying the TB may be based on, without limitation, a layer 1 identifier of the transmitting UE, a unicast/groupcast identifier, and/or a hashing function of an index associated with the sub-slot. In some aspects, the hashing function may include a message digest hash algorithm (e.g., MD4, MD5) and/or a secure hash algorithm (e.g., SHA-1, SHA-2).

In some aspects, the transmitting UE may receive the indicator indicating whether the TB was successfully received by the receiving UE in PSFCH resources based on an offset from resources associated with the sub-slot. In some aspects, the CG may indicate to a receiving UE the PSFCH resources associated with a sub-PSSCH in the sub-slot. The transmitting UE may transmit the CG to the receiving UE. Additionally or alternatively, the BS may transmit the CG to the receiving UE. The CG may indicate one or more PSFCH resources for transmission of HARQ feedback (e.g., ACK/NACK feedback) associated with a corresponding sub-PSSCH in the sub-slot. For example, the CG may indicate an offset between the sub-slot (e.g., a starting symbol of the sub-slot or an ending symbol of the sub-slot) and a corresponding PSFCH resource (e.g., a time and/or frequency domain resource) in which HARQ feedback, corresponding to the sub-slot, is to be transmitted. In this regard, the offset may be indicated as a number of symbols to enable greater scheduling flexibility and reduced latency as compared to signaling a slot for the HARQ feedback.

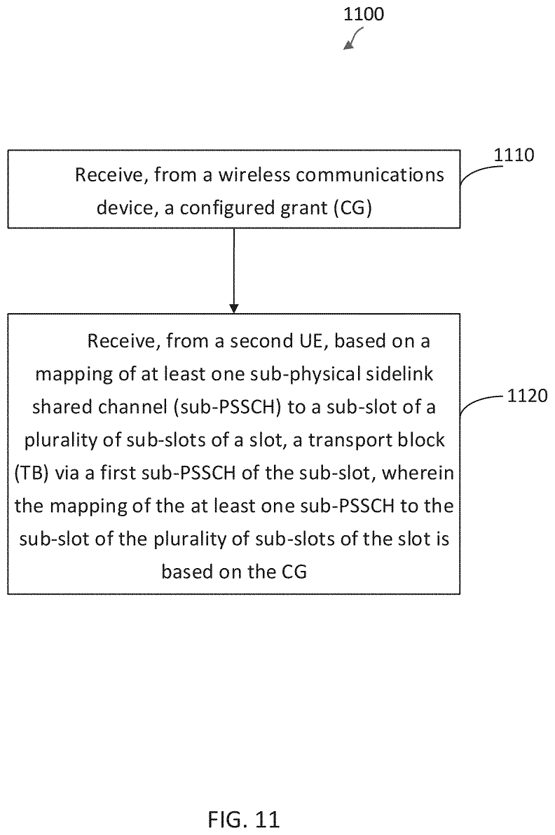

FIG. 11 is a flow diagram of a communication method 1100 according to some aspects of the present disclosure. Aspects of the method 1100 can be executed by a computing device (e.g., a processor, processing circuit, and/or other suitable component) of a wireless communication device or other suitable means for performing the steps. For example, a wireless communication device, such as the UE 115 or UE 800, may utilize one or more components, such as the processor 802, the memory 804, the configured grant module 808, the transceiver 810, the modem 812, and the one or more antennas 816, to execute aspects of method 1100. The method 1100 may employ similar mechanisms as in the networks 100 and 200 and the aspects and actions described with respect to FIGS. 2-7. As illustrated, the method 1100 includes a number of enumerated steps, but the method 1100 may include additional steps before, after, and in between the enumerated steps. In some aspects, one or more of the enumerated steps may be omitted or performed in a different order.

At 1110, the method 1100 includes a UE (e.g., the UE 115 or the UE 800) receiving, from a wireless communications device, a configured grant (CG). The UE may receive the CG from another UE (e.g., a transmitting UE). In this regard, the UE may receive the CG from the transmitting UE via SCI (e.g., first stage SCI-1). Additionally or alternatively, the UE may receive the CG from a BS. In this regard, the UE may receive the CG from the BS using RRC signaling. In some instances, the CG may provide the UE with resources to use in receiving a TB and/or one or more retransmissions (e.g., 1, 2, or other number of retransmissions) of the TB. By assigning the CG resources to the UE, the wireless network eliminates the packet transmission delay for a scheduling request procedure and increases the utilization ratio of allocated periodic radio resources. The CG may reduce the delay caused by the dynamic scheduling request procedure by pre-allocating sidelink radio resources for use by UEs for sidelink communications. For example, the UE may receive a CG with one or more slot resources (e.g., one, two, three, or other number of slot resources) in a CG period. In some instances, the BS assigns a set of sidelink resources to a UE for each sub-slot of each slot. Aspects of the present disclosure may eliminate the need for an SCI-2 in the sub-PSSCH and the information that may be included in the SCI-2 may be transmitted to the UE in the CG. By receiving the information via the CG and eliminating the SCI-2, the UE may reduce computing resources and power consumption as compared to receiving the information via the SCI-2. For example, the UE may reduce power consumption by not performing blind decoding on the SCI-2.

At 1120, the method 1100 includes the UE receiving a TB from the transmitting UE based on a mapping of at least one sub-PSSCH to a sub-slot of a plurality of sub-slots of a slot. In some aspects, the mapping of the at least one sub-PSSCH to the sub-slot of the plurality of sub-slots of the slot is based on the CG received by the UE at 1110. The UE may monitor for the TB in the sub-PSSCH in a subset of the plurality of sub-slots. In this regard, the UE may monitor a subset of sub-PSSCHs for the TB. For example, the CG may include a sub-slot pattern that includes the sub-PSSCHs to be monitored. The sub-slot pattern may indicate which sub-slots may be used to receive TBs. For example, the sub-slot pattern may indicate, one or more sub-slots (e.g., 1, 2, 3, 4, etc., including all of the sub-slots) in the slot are assigned to a particular receiving UE. In some instances, the sub-slot pattern may indicate every second and/or third sub-slot is assigned to a particular UE. This method may facilitate the UE to periodically receive TBs in different time periods based on the sub-slot pattern. Any suitable sub-slot pattern may be utilized.

In some aspects, the UE may receive the TB based on a UE destination identifier (e.g., a layer 2 UE destination identifier) identifying the intended receiving UE. The UE may have a unique layer 2 (e.g., MAC layer) identifier that distinguishes the UE from other UEs. In some aspects, the CG may map the same time/frequency resources to multiple UEs. Each of the multiple UEs having the same resource map may monitor the mapped resources and decode the TBs in those resources. The TB may include a layer 2 UE identifier that indicates which of the multiple UEs the TB was intended for. The UE may compare the layer 2 UE identifier in the TB to its own layer 2 UE identifier to determine whether it is the intended receiver of the TB.

In some aspects, the UE may receive, from the transmitting UE, an instruction that instructs the UE to enable (e.g., activate) a semi-persistent resource allocation mode. The SPS based resource allocation mode may include a mode in which the UE (e.g., the receiving UE) is allocated resources included in the CG semi-statically over a certain time interval or time period. In this regard, the time interval or time period may include the CG period (e.g., 1, 2, 3, or more slots). In some aspects, a BS may transmit an instruction to the receiving UE to enable the SPS resource allocation mode when the receiving UE is in coverage range of the BS. In this regard, the BS may transmit an instruction to the receiving UE to enable the SPS resource allocation mode via a PDCCH. When the receiving UE is out of coverage range of the BS, the transmitting UE may transmit an instruction to the receiving UE to enable the SPS resource allocation mode via SCI (e.g., first stage SCI-1) or other signaling. The transmitting UE may receive an indicator from the BS indicating that the receiving UE is out of the coverage range of the BS. The transmitting UE may transmit the instruction to the receiving UE to enable the SPS resource allocation mode based on the indicator from the BS.

By way of non-limiting examples, the following aspects are included in the present disclosure.

Aspect 1 includes a method of wireless communication performed by a first user equipment (UE), the method comprising receiving, from a base station (BS), a configured grant (CG); and transmitting, to a second UE based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

Aspect 2 includes the method of aspect 1, wherein the CG comprises a CG period; and further comprising transmitting, periodically to the second UE, a plurality of TBs based on the CG period.

Aspect 3 includes the method of any of aspects 1-2, wherein at least one TB of the plurality of TBs comprises padding.

Aspect 4 includes the method of any of aspects 1-3, further comprising refraining from transmitting a second stage sidelink control information (SCI-2) during the sub-slot.

Aspect 5 includes the method of any of aspects 1-4, wherein the transmitting the TB comprises transmitting, to the second UE, the TB in a first subset of sub-slots of the plurality of sub-slots of the slot, wherein the first subset of sub-slots includes the sub-slot; and further comprising transmitting, to a third UE, another TB in a second subset of sub-slots of the plurality of sub-slots, wherein the second subset of sub-slots is different from the first subset of sub-slots.

Aspect 6 includes the method of any of aspects 1-5, further comprising assigning the first sub-PSSCH to the second UE; and assigning the same first sub-PSSCH to a third UE.

Aspect 7 includes the method of any of aspects 1-6, wherein the transmitting the TB comprises transmitting, to the second UE, the TB in the assigned first sub-PSSCH in a first time period; and further comprising transmitting, to the third UE, another TB in the assigned first sub-PSSCH in a second time period.

Aspect 8 includes the method of any of aspects 1-7, wherein transmitting the TB is based on a layer 2 UE destination identifier associated with the second UE; and transmitting the another TB is based on the layer 2 UE destination identifier associated with the third UE.

Aspect 9 includes the method of any of aspects 1-8, wherein the CG indicates at least one of: resources associated with the sub-slot of the plurality of sub-slots; a size of the TB; a modulation and coding scheme associated with the first sub-PSSCH; an identifier associated with the second UE; a pattern associated with a plurality of sub-PSSCHs, wherein the plurality of sub-PSSCHs includes the first sub-PSSCH; or a demodulation reference signal (DMRS) configuration associated with the plurality of sub-slots of the slot.

Aspect 10 includes the method of any of aspects 1-9, further comprising receiving, from the BS, a plurality of CGs associated with the plurality of sub-slots, wherein the plurality of CGs includes the CG; and the plurality of sub-slots includes the sub-slot.

Aspect 11 includes the method of any of aspects 1-10, wherein the CG comprises at least one physical sidelink feedback channel resource mapped to each sub-slot of the plurality of sub-slots.

Aspect 12 includes the method of any of aspects 1-11, further comprising receiving, from the BS, an instruction that instructs the first UE to transmit the CG to the second UE; and transmitting, to the second UE, the CG based on receiving the instruction.

Aspect 13 includes the method of any of aspects 1-12, further comprising transmitting, to the second UE, an instruction that instructs the second UE to enable a semi-persistent resource allocation mode.

Aspect 14 includes the method of any of aspects 1-13, further comprising receiving, from the second UE, an indicator indicating whether the TB was successfully received, wherein the indicator is received in resources based on an index associated with the sub-slot.

Aspect 15 includes the method of any of aspects 1-14, further comprising: receiving, from the second UE, an indicator indicating whether the TB was successfully received, wherein the indicator is received in resources based on an offset from resources associated with the sub-slot.

Aspect 16 includes a method of wireless communication performed by a first user equipment (UE), the method comprising receiving, from a wireless communications device, a configured grant (CG); and receiving, from a second UE, based on a mapping of at least one sub-physical sidelink shared channel (sub-PSSCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

Aspect 17 includes the method of aspect 16, further comprising monitoring for the first sub-PSSCH in a subset of the plurality of sub-slots, wherein the subset of the plurality of sub-slots includes the sub-slot.

Aspect 18 includes the method of any of aspects 16-17, wherein the CG comprises a CG period; and further comprising receiving, periodically from the second UE, a plurality of TBs based on the CG period.

Aspect 19 includes the method of any of aspects 16-18, wherein receiving the TB is based on a layer 2 UE destination identifier associated with the first UE.

Aspect 20 includes the method of any of aspects 16-19, further comprising receiving, from the second UE, an instruction that instructs the UE to enable a semi-persistent resource allocation mode.

Aspect 21 includes the method of any of aspects 16-20, wherein the wireless communications device comprises a base station (BS).

Aspect 22 includes the method of any of aspects 16-21, wherein the wireless communications device comprises the second UE.

Aspect 23 includes a user equipment (UE) comprising a transceiver, a memory, and a processor coupled to the transceiver and the memory, the UE configured to perform any one of aspects 1-15.

Aspect 24 includes a user equipment (UE) comprising a transceiver, a memory, and a processor coupled to the transceiver and the memory, the UE configured to perform any one of aspects 16-22.

Aspect 25 includes a non-transitory computer-readable medium storing one or more instructions for wireless communication, the one or more instructions comprising one or more instructions that, when executed by one or more processors of a user equipment, cause the one or more processors to perform any one of aspects 1-15.

Aspect 26 includes a non-transitory computer-readable medium storing one or more instructions for wireless communication, the one or more instructions comprising one or more instructions that, when executed by one or more processors of a user equipment, cause the one or more processors to perform any one of aspects 16-22.

Aspect 27 includes a user equipment (UE) comprising one or more means to perform any one or more of aspects 1-15.

Aspect 28 includes a user equipment (UE) comprising one or more means to perform any one or more of aspects 16-22.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a DSP, an ASIC, an FPGA or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates an inclusive list such that, for example, a list of [at least one of A, B, or C] means A or B or C or AB or AC or BC or ABC (i.e., A and B and C).

As those of some skill in this art will by now appreciate and depending on the particular application at hand, many modifications, substitutions and variations can be made in and to the materials, apparatus, configurations and methods of use of the devices of the present disclosure without departing from the spirit and scope thereof. In light of this, the scope of the present disclosure should not be limited to that of the particular instances illustrated and described herein, as they are merely by way of some examples thereof, but rather, should be fully commensurate with that of the claims appended hereafter and their functional equivalents.

What is claimed is:

1. A method of wireless communication performed by a first user equipment (UE), the method comprising:
receiving, from a base station (BS), a configured grant (CG); and
transmitting, to a second UE based on a mapping of at least one sub-physical sidelink shared channel (sub-PS SCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

2. The method of claim 1, wherein:
the CG comprises a CG period; and
further comprising:
transmitting, periodically to the second UE, a plurality of TBs based on the CG period.

3. The method of claim 2, wherein at least one TB of the plurality of TBs comprises padding.

4. The method of claim 1, further comprising:
refraining from transmitting a second stage sidelink control information (SCI-2) during the sub-slot.

5. The method of claim 1, wherein the transmitting the TB comprises:
transmitting, to the second UE, the TB in a first subset of sub-slots of the plurality of sub-slots of the slot, wherein the first subset of sub-slots includes the sub-slot; and
further comprising:
transmitting, to a third UE, another TB in a second subset of sub-slots of the plurality of sub-slots, wherein the second subset of sub-slots is different from the first subset of sub-slots.

6. The method of claim 1, further comprising:
assigning the first sub-PSSCH to the second UE; and
assigning the same first sub-PSSCH to a third UE.

7. The method of claim 6, wherein the transmitting the TB comprises:
transmitting, to the second UE, the TB in the assigned first sub-PSSCH in a first time period; and
further comprising:
transmitting, to the third UE, another TB in the assigned first sub-PSSCH in a second time period.

8. The method of claim 7, wherein:
transmitting the TB is based on a layer 2 UE destination identifier associated with the second UE; and
transmitting the another TB is based on the layer 2 UE destination identifier associated with the third UE.

9. The method of claim 1, wherein the CG indicates at least one of:
resources associated with the sub-slot of the plurality of sub-slots;
a size of the TB;
a modulation and coding scheme associated with the first sub-PSSCH;
an identifier associated with the second UE;
a pattern associated with a plurality of sub-PSSCHs, wherein the plurality of sub-PSSCHs includes the first sub-PSSCH; or
a demodulation reference signal (DMRS) configuration associated with the plurality of sub-slots of the slot.

10. The method of claim 1, further comprising
receiving, from the BS, a plurality of CGs associated with the plurality of sub-slots, wherein:
the plurality of CGs includes the CG; and
the plurality of sub-slots includes the sub-slot.

11. The method of claim 1, wherein:
the CG comprises at least one physical sidelink feedback channel resource mapped to each sub-slot of the plurality of sub-slots.

12. The method of claim 1, further comprising:
receiving, from the BS, an instruction that instructs the first UE to transmit the CG to the second UE; and
transmitting, to the second UE, the CG based on receiving the instruction.

13. The method of claim 1, further comprising:
transmitting, to the second UE, an instruction that instructs the second UE to enable a semi-persistent resource allocation mode.

14. The method of claim 1, further comprising:
receiving, from the second UE, an indicator indicating whether the TB was successfully received, wherein the indicator is received in resources based on an index associated with the sub-slot.

15. The method of claim 1, further comprising:
receiving, from the second UE, an indicator indicating whether the TB was successfully received, wherein the indicator is received in resources based on an offset from resources associated with the sub-slot.

16. A method of wireless communication performed by a first user equipment (UE), the method comprising:
receiving, from a wireless communications device, a configured grant (CG); and
receiving, from a second UE, based on a mapping of at least one sub-physical sidelink shared channel (sub-PS SCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

17. The method of claim 16, further comprising:
monitoring for the first sub-PSSCH in a subset of the plurality of sub-slots, wherein the subset of the plurality of sub-slots includes the sub-slot.

18. The method of claim 16, wherein:
the CG comprises a CG period; and
further comprising:
receiving, periodically from the second UE, a plurality of TBs based on the CG period.

19. The method of claim 16, wherein:
receiving the TB is based on a layer 2 UE destination identifier associated with the first UE.

20. The method of claim 16, further comprising:
receiving, from the second UE, an instruction that instructs the UE to enable a semi-persistent resource allocation mode.

21. The method of claim 16, wherein the wireless communications device comprises a base station (BS).

22. The method of claim 16, wherein the wireless communications device comprises the second UE.

23. A first user equipment (UE) comprising a transceiver, a memory, and a processor coupled to the transceiver and the memory, the first UE configured to:
receive, from a base station (BS), a configured grant (CG); and
transmit, to a second UE based on a mapping of at least one sub-physical sidelink shared channel (sub-PS SCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

24. The first UE of claim 23, wherein:
the CG comprises a CG period; and
the first UE is further configured to:
transmit, periodically to the second UE, a plurality of TBs based on the CG period, wherein at least one TB of the plurality of TBs comprises padding.

25. The first UE of claim 23, wherein the first UE is further configured to:
refrain from transmitting a second stage sidelink control information (SCI-2) during the sub-slot.

26. The first UE of claim 23, wherein the first UE is further configured to:
transmit, to the second UE, the TB in a first subset of sub-slots of the plurality of sub-slots of the slot, wherein the first subset of sub-slots includes the sub-slot; and
transmit, to a third UE, another TB in a second subset of sub-slots of the plurality of sub-slots, wherein the second subset of sub-slots is different from the first subset of sub-slots.

27. The first UE of claim 23, wherein the first UE is further configured to:
transmit, to the second UE, the TB in the assigned first sub-PSSCH in a first time period based on a layer 2 UE destination identifier associated with the second UE; and
transmit, to a third UE, another TB in the assigned first sub-PSSCH in a second time period based on the layer 2 UE destination identifier associated with the third UE.

28. The first UE of claim 23, wherein the first UE is further configured to:
receive, from the BS, an instruction that instructs the first UE to transmit the CG to the second UE; and
transmit, to the second UE, the CG based on receiving the instruction.

29. A first user equipment (UE) comprising a transceiver, a memory, and a processor coupled to the transceiver and the memory, the first UE configured to:
receive, from a wireless communications device, a configured grant (CG); and
receive, from a second UE, based on a mapping of at least one sub-physical sidelink shared channel (sub-PS SCH) to a sub-slot of a plurality of sub-slots of a slot, a transport block (TB) via a first sub-PSSCH of the sub-slot, wherein the mapping of the at least one sub-PSSCH to the sub-slot of the plurality of sub-slots of the slot is based on the CG.

30. The first UE of claim 29, wherein the wireless communications device comprises:
a base station (BS); or
the second UE.
